(19) United States
(12) Patent Application Publication
(10) Pub. No.: US 2023/0023501 A1
(43) Pub. Date: Jan. 26, 2023

(54) POLYPHENOL COMPOSITIONS AND SUGARS INCLUDING VINASSE AND/OR DIGESTATE AND METHODS OF THEIR PREPARATION

(71) Applicant: NUTRITION SCIENCE DESIGN PTE. LTD, Singapore (SG)

(72) Inventors: David KANNAR, Singapore (SG); Tracey Ann HAY, Singapore (SG)

(73) Assignee: NUTRITION SCIENCE DESIGN PTE. LTD, Singapore (SG)

(21) Appl. No.: 17/786,113

(22) PCT Filed: Dec. 23, 2020
(86) PCT No.: PCT/SG2020/050777

§ 371 Date: Jun. 16, 2022

(30) Foreign Application Priority Data
Dec. 23, 2019 (SG) 10201913020W

(51) Int. Cl. C13B 50/00; A23L 5/20

(52) U.S. Cl. CPC C13B 50/006; A23L 5/273

(57) ABSTRACT

The present invention provides a polyphenol composition comprising sugarcane bagasse and/or sugarcane vinasse. Methods of lowering the odour of the polyphenol composition using activated carbon. Methods of preparing the polyphenol composition following fermentation and distillation of a sugarcane derived product. Sugars and foods/beverages comprising the polyphenol composition and methods of preparing those.

### FIELD OF THE INVENTION

The present invention relates to polyphenol compositions, processes for the preparation of the polyphenol compositions, sugars containing polyphenols and methods of making said sugars.

### BACKGROUND OF THE INVENTION

Vinasse is a by-product of the fermentation of carbohydrates including sugar that is produced in large quantities. The carbohydrate can be in the form of sugar cane, sugar beet, a sugar containing product of sugar processing, a starch crop or a product of their processing, a cellulosic material and/or a product of their processing. For each litre of alcohol produced in the sugarcane industry, 15 litres of vinasse can be generated, which is commonly about 93% water and about 7% solids (although this can vary and vinasse is often concentrated for use and/or sale).

For example, sugar cane and sugar beet are crushed to produce sugar cane or sugar beet juice and a fibrous pulp called bagasse. The sugar cane and sugar beet juice are traditionally further processed to prepare crystalline sugar and molasses (among other by-products). The sugar from the sugar cane and sugar beet sourced sugar products including the sugar juice, molasses and various other sugar containing by-products can be fermented. The fermentation is commonly by yeast.

Fermentation of sugar can produce alcohol including rum, cachaca, guaro and mekhong whiskey, which are produced by fermentation of sugar juice and/or molasses. Fermentation can also produce bioethanol or ascorbic acid. The vinasse remaining after distillation of the alcohol following fermentation of sugar is generally partially dehydrated until its viscosity is similar to that for molasses and then sold.

Vinasse is used as a fertilizer, in nutritive solutions for hydroponics, in the production of methane, in culture media for plant tissue culture and algae growth.

Not all vinasse is repurposed and the disposal of vinasse poses serious environmental problems for soils and water bodies. Because of the large quantities of vinasse produced, developing further uses for vinasse is likely to assist the environment and minimise waste.

Recently anaerobic digestion has been investigated as a technology useful in repurposing certain waste streams. The process employs specialised bacteria to break down organic waste in an oxygen depleted environment to produce biogas, a liquid organic residue called digestate and a solid waste called sludge. Biogas is a mixture of methane, carbon dioxide, other gases, and water. Biogas can be combusted for heat and electricity or cleaned and compressed to be used as a vehicle fuel or as a substitute for natural gas. Digestate is a fibrous solid/sludge that can be used in the same way as compost for soil improvement.

A wide variety of organic feedstocks have been used for anaerobic digestion. Feedstocks are normally organic wastes such as the organic fraction of municipal solid waste, food waste or animal manure. There are numerous factors to consider in evaluating the type of feedstock available to design an anaerobic digestion system including source, composition, contaminants, storage system, and seasonal fluctuation.

Vinasse produced from sugar cane is also called dunder. Dunder is rich in phytochemicals, including polyphenols. Polyphenols have been linked with health benefits, including benefits from antioxidant activity.

One of the difficulties with identifying new repurposing options for vinasse and/or digestate is the undesirable odour of these waste streams. The odour is often, at least in part, due to volatile organic compounds (such as methane), volatile amines, mercaptans or combinations thereof.

Developing edible products rich in polyphenols is desirable as consumption of polyphenols had been associated with various health benefits. Developing further uses for vinasse, dunder, and/or digestate is also desirable due to the environmental impact of vinasse and dunder disposal.

There is a need for further sources of edible antioxidants, phytochemicals and/or polyphenols. There is a need for further foods including phytochemicals such as polyphenols. There is a need to improve the health benefits of known foods by including phytochemicals such as polyphenols in known foods.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

Low and very low glycaemic sugars have been developed (see the detailed description). These sugars include significant amounts of polyphenols. Not all sugar sources naturally include significant amounts of polyphenols, for example beet sugar. Therefore, it was useful to develop a concentrated polyphenol composition for addition to sugars that could not or were not convenient to be prepared retaining natural polyphenols. Polyphenols are in molasses. However, molasses also contains sugar. The sugar in molasses complicates addition of polyphenols to a sugar to achieve a desired polyphenol to sugar ratio. Therefore, a new source of polyphenol sugars was sought. The inventors investigated various sugar cane waste streams and identified vinasse and digestate as suitable options. To the inventor's knowledge, vinasse and digestate waste products have never before been repurposed for use in food suitable for human consumption.

Polyphenol Compositions of the Invention

In a first aspect, the present invention provides a food grade and/or low odour polyphenol composition comprising liquid or solid sugar cane vinasse and/or sugar cane digestate. Optionally, the methane content of the sugar cane vinasse and/or sugar cane digestate is reduced. Optionally, the volatile organic compound content of the sugar cane vinasse and/or sugar cane digestate is reduced. Optionally, the volatile amine (including ammonia) and/or volatile mercaptan (including hydrogen sulphide) content of the sugar cane vinasse and/or sugar cane digestate is reduced.

Preferably, the vinasse and/or digestate has 500 to 15,000 mg GAE/100 g polyphenols. The vinasse and/or digestate is optionally 500 to 5.000 mg GAE/100 g polyphenols, 500 to 3,000 mg/100 g polyphenols, 500 to 2,000 mg GAE/100 g polyphenols, 5,000 to 15,000 mg GAE/100 g polyphenols, 6,000 to 12,000 mg GAE/100 g polyphenols, about 10,000 mg GAE/100 g polyphenols or about 1,000 mg GAE/100 g polyphenols.

Optionally, the vinasse, digestate or vinasse digestate (ie a digestate of vinasse) has no odour or is odourless. Optionally, the vinasse, digestate or vinasse digestate has an odour intensity of 0-3 according to the VDI 3882-1 olfactometry standard. Alternatively, the vinasse, digestate or vinasse digestate has an odour intensity of 0-2, 1-3, 1-2, 2-3, 0, 1, 2, or 3 according to the VDI 3882-1 olfactometry standard for measuring odour intensity.

Alternatively, the polyphenol composition has no odour when combined with white refined sucrose to produce a 100 mg GAE polyphenol/100 g carbohydrate sugar. Alternatively, the polyphenol composition has no odour when combined with white refined sucrose or raw mill sugar to produce a 10, 15, 20, 30, 40 or 50 mg GAE polyphenol/100 g carbohydrate sugar. Polyphenol compositions meeting this test are reduced odour compositions of the invention.

The vinasse and/or digestate is optionally 10-15% ash. The vinasse and/or digestate is optionally Pol % w/w, preferably Pol % w/w, Pol % w/w. The vinasse and/or digestate is optionally sugar free. The vinasse and/or digestate is optionally 20-25 μS/cm conductivity.

Optionally, the sugar cane vinasse or sugar cane digestate is not an extract. Optionally, the sugar cane vinasse or sugar cane digestate is a filtrate, preferably an affinity filtration filtrate such as an activated carbon filtrate and/or an ion-exchange resin filtrate.

In some embodiments, the vinasse has a Chemical Oxygen Demand (COD) of 30-150 (or 50-150) g O₂/L. The biochemical oxygen demand (BOD) is optionally about 30-80% of the COD. The COD/BOD ratio is optionally then 1.1-2 or 1.2-1.9.

In some embodiments, the vinasse includes 5-35% (or 5-20%) protein, 11-65% (or 15-30%) ash, 1-25 (or 5-25%) carbohydrates, 0-10% (or 1-6%) glycerol, and 30-85% (or 30-80%) water by weight. In alternate embodiments, the vinasse includes 70-85% moisture, about 10-20% ash, about 5-10% protein, under 1% carbohydrates. In some embodiments, the vinasse comprises water, organic solids, minerals (such as potassium, calcium, and magnesium) and polyphenols. In some embodiments, the vinasse comprises, 15-30% (or 20-25%) lignin, 8-20% (or 10-15%) cellulose, 5-10% hemicellulose ie one or more of a ratio of 1.5:1 to 6:1 or 2:1 to 5:1 lignin to hemicellulose, 0.8:1 to 4:1 or 1:1 to 3:1 cellulose to hemicellulose, and 0.75:1 to 3.75:1 or 1:1 to 3:1 or or 1.3:1 to 2.5:1 lignin to cellulose by solid weight. Optionally, the vinasse includes the minerals phosphate, nitrate, sulphate, and/or calcium. Optionally, the vinasse further includes sodium and potassium. Optionally, the vinasse includes 500-1,500 mg/mL nitrate. Optionally, the vinasse includes 50-200 mg/mL phosphate. Optionally, the vinasse includes 500-4,000 mg/mL sulphate. Optionally, the vinasse includes 500-3,000 mg/mL calcium.

Optionally, the specific gravity of the vinasse is 0.5-2, 0.8-1.5 or 1-1.3 at 20° C. Optionally, the pH is 3.5-6.8, 3.5-5.0, 4.0-4.5, 4.9-5.4 or 5.4-6.8. Optionally, the vinasse is soluble. Alternatively, the vinasse includes 8,000-12,000 (or about 10,000) mg/I dissolved solids and optionally 4,000-5,000 (or 4,000-4,500) mg/I suspended solids. Optionally, the vinasse is 8-15 (or 10-13) ° Brix (° Bx) at 28° C., has a relative density of 1-1.8 (or 1.2-1.4 (kg/I) at 20° C., a viscosity of about 75-125 (or about 100) cps at 20° C., and/or has a boiling point over 80 or 100° C.

In some embodiments, the vinasse has a dry matter content of 40-60 or 45-50% by weight.

In some embodiments, the sugar cane vinasse digestate has a pH of 6.5 to 9.5. For a solid digestate, the pH is the pH of a 10% w/v solution of the digestate in water. Optionally, the digestate is 5-20% w/w or 10-15% w/w ash. Optionally, the digestate is less than 1% or less than 0.5% or less than 0.01% digestible carbohydrate including sugar.

Optionally, the sugar cane vinasse digestate had 9-11% solids as determined by a Brix Meter.

The sugar cane vinasse digestate also had less than 1 mg/kg arsenic, less than 0.30 mg/kg antimony; less than 0.03 mg/kg cadmium, 1.9 mg/kg selenium; less than 0.004 mg/kg mercury; and 0.12 mg/kg lead.

In a second aspect, the present invention provides powdered vinasse and/or digestate including 500 to 15,000 mg GAE polyphenols/100 g, wherein the powdered vinasse and/or digestate has no odour. Optionally, the vinasse, digestate or vinasse digestate has an odour intensity of 0-3 according to the VDI 3882-1 olfactometry standard. Alternatively, the vinasse, digestate or vinasse digestate has an odour intensity of 0-2, 1-3, 1-2, 2-3, 0, 1, 2, or 3 according to the VDI 3882-1 olfactometry standard for measuring odour intensity.

The powdered vinasse and/or digestate is, optionally, one or more of food grade and low odour, preferably no odour. The powdered vinasse and/or digestate is optionally soluble in water.

Powdered sugar cane vinasse digestate optionally has a pH 9.0 to 9.6 (preferably 9-9.5) when 1 g of powder is dissolved in 10 ml water (ie 10% w/v).

Optionally, the powdered sugar cane vinasse digestate is <40% w/v plant fibre, <35% w/v ash and/or ≥7% w/v polyphenols. Optionally, there are more than 7000 mg GAE polyphenols/100 g. Optionally, the powder is less than 5% (preferably less than 2%) moisture by weight. Optionally, the powder is less than 2 mg/kg heavy metals. Optionally, the powder has a total plate count of 15,000 CFU/g, a yeast and mould plate count of 500 CFU/g,absent salmonella or a combination thereof. Preferably, the powder has a total plate count of 12,000 CFU/g or the powder has a total plate count of 10,000 CFU/g. Preferably, the yeast count is <10 CFU/g. Preferably the mould count is <40 CFU/g.

Optionally, the sugar cane vinasse or sugar cane digestate is not an extract. Optionally, the sugar cane vinasse or sugar cane digestate is an affinity filtrate, a size filtrate and an affinity filtrate, or a dried product thereof.

### Preparation of the Polyphenol Compositions of the Invention

In a third aspect, the present invention provides a method comprising spray drying liquid sugar cane digestate and/or sugar cane vinasse. Optionally, the inlet temperature for the spray drier is 160-200° C. Optionally, the liquid sugar cane digestate and/or sugar cane vinasse is a liquid polyphenol composition of the invention and/or the spray drying prepares a powdered polyphenol composition of the invention. Preferably, the method comprises spray drying liquid sugar cane vinasse digestate to prepare powdered sugar cane vinasse digestate. Optionally, prior to spray drying the high boiling point fraction of the digestate/vinasse is removed under reduced pressure. Optionally, the liquid sugar cane digestate and/or sugar cane vinasse is a composition according to the first or second aspects of the invention or their embodiments. Optionally, the liquid sugar cane digestate and/or sugar cane vinasse spray dried has been treated with activate carbon or resin in accordance with the fourth aspect of the invention, its alternatives, options or embodiments.

In some embodiments, the powdered product of the third aspect of the invention is reconstituted as a liquid by combining the powder with water (such as distilled water) or affination syrup or molasses. Optionally, the liquid prepared is 30-50° Brix (preferably 40° Brix).

In some embodiments, the powdered product of the third aspect of the invention is not a dried extract. Optionally, the powdered product is prepared from digestate/vinasse without solvent extraction step.

In some embodiments of the third aspect of the invention, no organic solvent is added to the digestate/vinasse. In some embodiments of the third aspect of the invention, no alcoholic solvent is added to the digestate/vinasse. In some embodiments of the third aspect of the invention, no ethanol is added to the digestate/vinasse.

In some embodiments of the third aspect of the invention, no organic solvent is added to the digestate/vinasse or material derived from the digestate/vinasse. In some embodiments of the third aspect of the invention, no alcoholic solvent is added to the digestate/vinasse or material derived from the digestate/vinasse. In some embodiments of the third aspect of the invention, no ethanol is added to the digestate/vinasse or material derived from the digestate/vinasse.

In a fourth aspect, the present invention provides a method of reducing the odour of sugar cane digestate and/or sugar cane vinasse (preferably vinasse digestate) starting material comprising affinity filtration of the sugar cane digestate and/or sugar cane vinasse (preferably vinasse digestate) starting material to produce a reduced odour sugar cane digestate and/or sugar cane vinasse (preferably vinasse digestate). Optionally, the affinity filtration is activated carbon filtration and/or resin filtration. Optionally, the sugar cane digestate and/or sugar cane vinasse (preferably vinasse digestate) starting material has an odour intensity of 4-6 according to the VDI 3882-1 olfactometry standard. Alternatively, the sugar cane digestate and/or sugar cane vinasse (preferably vinasse digestate) starting material has an odour intensity of 5-6, 4-6, 4, 5, or 6 according to the VDI 3882-1 olfactometry standard.

Optionally, the reduced odour vinasse, digestate or vinasse digestate has no odour or an odour intensity of 0-3 according to the VDI 3882-1 olfactometry standard. Alternatively, the reduced odour vinasse, digestate or vinasse digestate has an odour intensity of 0-2, 1-3, 1-2, 2-3, 0, 1, 2, or 3 according to the VDI 3882-1 olfactometry standard for measuring odour intensity.

Optionally, any insoluble fraction of the vinasse/digestate is removed before spray drying, for example, by size filtration.

In an alternative fourth aspect, the present invention provides a method of reducing the odour of sugar cane digestate and/or sugar cane vinasse (preferably vinasse digestate) including contacting the liquid sugar cane digestate and/or sugar cane vinasse with activated carbon. The sugar cane digestate and/or sugar cane vinasse can be in a powdered form and dissolved in a solvent such as water prior to contact with the activated carbon. About 1-10 g powdered sugar cane digestate and/or sugar cane vinasse is optionally dissolved in about 100 ml of solvent (eg water such as distilled water or affination syrup).

In some embodiments, a commercially available activated carbon depth filter is used for the carbon filtration (such as a Seitz® Stax depth filter). Optionally, where required, the liquid or powdered sugar cane digestate and/or sugar cane vinasse is diluted to 5-30° Brix (for example 5-20, 5-15 or 10° Brix) before filtration. Optionally, dilution is in water or a water based solution such as affination syrup or other sugar processing by-product such as molasses. Preferably, the solution or syrup used for dilution is low in reducing sugars (for example, less than 2%, 1%, 0.5% w/w reducing sugars) and/or includes polyphenols (for example, 100-1,500 mg GAE polyphenols/100 g).

Optionally, the sugar cane digestate and/or sugar cane vinasse is filtered through the depth filter at a 5-15 (preferably 10) ml/minute flow rate. Optionally, the filtration is at a differential pressure of 0.5-2.0 (or 0.5-1.5) bar. Optionally, the commercial filter has 0.5-1.5 (or 0.7-1.4 or 1.0-1.5) kg activated carbon. Optionally, the commercial filter is a decolourisation filter. Optionally filtration occurs at 25-60° C.

In alternate embodiments, loose activated carbon is used. The activated carbon is preferably pre-washed with distilled water and dried to prepare powdered activated carbon. The prewash is optionally continued until the distilled water runs clear, for example for up to 48 hours. The drying is optionally in an oven, for example at 80-120° C., preferably about 100° C. Optionally, the liquid sugar cane digestate and/or sugar cane vinasse and loose activated carbon are diluted 10-30 times (ie 5 ml into 50-150 ml), preferably about 12 times in distilled water.

Optionally, the combined sugar cane digestate and/or sugar cane vinasse and loose activated carbon (optionally diluted as described above) are agitated by mechanical stirring for at least 30 minutes or at least 60 minutes. The mixture is then filtered to remove the activated carbon.

Optionally, about 0.2-0.7 g, 0.3-0.5 g or about 0.4 g activated carbon is used per 1 g of liquid sugar cane digestate and/or sugar cane vinasse.

In an alternative fourth aspect, the present invention provides a method of reducing the odour of sugar cane digestate and/or sugar cane vinasse (preferably vinasse digestate) including contacting the liquid sugar cane digestate and/or sugar cane vinasse with resin. The sugar cane digestate and/or sugar cane vinasse can be in a powdered form and dissolved in a solvent such as water prior to contact with the resin. About 1-10 g powdered sugar cane digestate and/or sugar cane vinasse is optionally dissolved in about 100 ml of solvent (eg water such as distilled water or affination syrup or molasses).

In some embodiments, ion-exchange resin is used for reducing the odour of sugar cane digestate and/or sugar cane vinasse (preferably vinasse digestate). In some embodiments, the resin is an ion-exchange resin. In some embodiments, the resin is an adsorbent resin. In some embodiments, the adsorbent resin is functionalised. In some embodiments, the adsorbent resin is not functionalised. In some embodiments, the resin is made up of a styrenic matrix. In some embodiments, the resin is made up of an acrylic matrix. The person skilled in the art will appreciate that resins made up a sytrenic matrix are generally more hydrophobic than resins made up of an acrylic matrix. In some embodiments, the resin is a cationic resin, preferably a strongly cationic resin. In some embodiments, the cationic resin is operated in Na⁺ form. Cationic resins are effective in odour removal of against volatile amines (including ammonia) as well as volatile compounds with polar groups, such as volatile mercaptans (including hydrogen sulphide). In some embodiments, the resin is an anionic resin, preferably a strongly anionic resin. Anionic resins are effective in odour removal of against volatile compounds with polar groups, such as volatile mercaptans (including hydrogen sulphide). In some embodiments, the anionic resin comprises quaternary amine functional groups, preferably operated in chloride form.

In some embodiments, hydrophobic resin is used for reducing the odour of sugar cane digestate and/or sugar cane vinasse (preferably vinasse digestate). In some embodiments, the hydrophobic resin is sephadex LH-20, XAD or FPX66 resin.

In some embodiments, the resin is A860S, A502PS or A420S resin. In some embodiments, the resin is MN150 or MN102. In some embodiments, one or more of sephadex LH-20, XAD, FPX66, A860S, A502PS, A420S, MN150 or MN102 resin is used for reducing the odour of sugar cane digestate and/or sugar cane vinasse (preferably vinasse digestate), either in the same step or in different steps.

In some embodiments, the liquid sugar cane digestate and/or sugar cane vinasse is contacted with resin in an agitated mixture, for instance, a stirred mixture. The resin is then filtered off the mixture. Optionally, resin agitation occurs at 25-60° C.

In some embodiments, the liquid sugar cane digestate and/or sugar cane vinasse is contacted with resin via passing the liquid sugar cane digestate and/or sugar cane vinasse through a column of resin. Optionally, the column of resin comprises more than one type of resin, either co-mingled or in separate sections of the column. Optionally, the sugar cane digestate and/or sugar cane vinasse is passed through the resin column at a flow rate of 1-6 bed volumes/hour (ie material flowing through the a bed containing 10 m³ of resin operating at 2 bed volumes/hour (BV/hr) would be flowing at 20 m³/hr. In some embodiments, the flow rate is 2-4 BV/hr, 2-3 BV/hr, 3-4 BV/hr, 2.5-3.5 BV/hr, 2 BV/hr, 3 BV/hr or 4 BV/hr. Optionally, the sugar cane digestate and/or sugar cane vinasse is passed through the resin column at a 5-15 (preferably 10) ml/minute flow rate. Optionally, the column is operated at a differential pressure of 0.5-2.0 (or 0.5-1.5) bar. Optionally, the resin column has 0.5-1.5 (or 0.7-1.4 or 1.0-1.5) kg of resin. Optionally resin filtration occurs at 25-60° C.

Optionally, where required, the liquid or powdered sugar cane digestate and/or sugar cane vinasse is diluted to 5-30° Brix (for example 5-20, 5-15 or 10° Brix) before introduction to the resin column or agitation with the resin. Optionally, dilution is in water or a water based solution such as affination syrup or other sugar processing by-product such as molasses. Preferably, the solution or syrup used for dilution is low in reducing sugars (for example, less than 2%, 1° A, 0.5% w/w reducing sugars) and/or includes polyphenols (for example, 100-1,500 mg GAE polyphenols/100 g).

In some embodiments the resin is food grade.

The person skilled in the art will appreciate that resins can be regenerated. For instance, a cationic resin can be regenerated with an acid wash. Similarly, an anionic resin can be regenerated with an alkaline wash. Cationic resins can also be washed with alkaline and/or neutral solutions and anionic resins can also be washed with acidic and/or neutral solutions as part of the regeneration process. After suitable washing steps, for instance, washing away non-neutral solutions with neutral solutions and/or washing with solutions comprising ions to be used in the active form of the resin (for example, washing with solutions comprising chloride to convert the quaternary amine functional groups on the resin into chloride form), the resin can be re-used.

In some embodiments, the liquid sugar cane digestate and/or sugar cane vinasse is contacted with resin and activated carbon. In some embodiments, the liquid sugar cane digestate and/or sugar cane vinasse is contacted with activated carbon prior to contact with resin. In some embodiments, the liquid sugar cane digestate and/or sugar cane vinasse is contacted with resin prior to contact with activated carbon.

The methods of contact with activated carbon and/or resin produce a liquid sugar cane digestate and/or sugar cane vinasse having lower odour than the starting sugar cane digestate and/or sugar cane vinasse.

Where the sugar cane digestate and/or sugar cane vinasse was diluted, it is optionally concentrated into a liquid sugar cane digestate and/or sugar cane vinasse having lower odour than the starting sugar cane digestate and/or sugar cane vinasse. Alternatively, following filtering the mixture is spray dried to form powdered sugar cane digestate and/or sugar cane vinasse having lower odour than the starting sugar cane digestate and/or sugar cane vinasse. The spray dried powder optionally has a 6 to 12 month shelf life in clear plastic bags, room temperature and 40-60% RH.

Optionally, before contact with the activated carbon and/or resin, after contact with the activated carbon and/or resin but before filtration, or after contact with the activated carbon and/or resin and filtration, the high boiling point fraction of the digestate/vinasse is removed under reduced pressure. Filtration, contact with activated carbon, contact with resin and removal of the high boiling point fraction of the digestate/vinasse under reduced pressure steps may be performed in any combination in any order.

In a further fourth aspect, the present invention provides a method of preparing a reduced odour sugar cane digestate and/or sugar cane vinasse (preferably vinasse digestate) comprising:
(a) selecting a solid or liquid sugar cane digestate and/or sugar cane vinasse;
(b) if required, diluting the solid or liquid sugar cane digestate and/or sugar cane vinasse to a viscosity suitable for filtration (eg 0-45 brix, 1-45 brix, 1-40 brix, 1-30 brix, 1-25 brix, 3-20 brix, 5-15 brix, 7-12 brix or about 10 brix)
(c) optionally size filtering the sugar cane digestate and/or sugar cane vinasse through a size filter to exclude particles above 500, 300, 200, 100, 50 microns;
(d) reducing the odour of sugar cane digestate and/or sugar cane vinasse through contacting with activated carbon or resin to produce a reduced odour sugar cane digestate and/or sugar cane vinasse, preferably contacting is via affinity filtering the sugar cane digestate and/or sugar cane vinasse through an affinity filter to produce an affinity filtered sugar cane digestate and/or sugar cane vinasse; and
(e) optionally concentrating the filtered sugar cane digestate and/or sugar cane vinasse by evaporation to a viscosity suitable for spray drying (eg 20-60 brix, 30-50 brix, 35-45 brix, or about 40 brix) and then spray drying the filtered sugar cane digestate and/or sugar cane vinasse to form a powdered sugar cane digestate and/or sugar cane vinasse.

In some embodiments, step (c), step (e) or both are required not optional. The size filtration, affinity filtration, evaporation, dilution and spray drying are as described elsewhere in relation to the fourth and alternate fourth aspects of the invention or in the detailed description and examples.

In a further fourth aspect, the present invention provides a method of preparing a reduced odour sugar cane digestate and/or sugar cane vinasse (preferably vinasse digestate) comprising:
(a) selecting a solid or liquid sugar cane digestate and/or sugar cane vinasse;
(b1) concentrating the sugar cane digestate and/or sugar cane vinasse by evaporation (eg to 20-60 brix, 30-50 brix, 35-45 brix, or about 40 brix);
(b2) diluting the concentrated filtered sugar cane digestate and/or sugar cane vinasse to a viscosity suitable for filtration (eg 0-45 brix, 1-45 brix, 1-40 brix, 1-30 brix, 1-25 brix, 3-20 brix, 5-15 brix, 7-12 brix or about 10 brix)
(c) optionally size filtering the sugar cane digestate and/or sugar cane vinasse through a size filter to exclude particles above 500, 300, 200, 100, 50 microns;
(d) reducing the odour of sugar cane digestate and/or sugar cane vinasse through contacting with activated carbon or resin to produce a reduced odour sugar cane digestate and/or sugar cane vinasse, preferably contacting is via affinity filtering the sugar cane digestate and/or sugar cane vinasse through an affinity filter to produce an affinity filtered sugar cane digestate and/or sugar cane vinasse;
(e) optionally concentrating the filtered sugar cane digestate and/or sugar cane vinasse to a viscosity suitable for spray drying (eg 20-60 brix, 30-50 brix, 35-45 brix, or about 40 brix); and
(f) spray drying the filtered sugar cane digestate and/or sugar cane vinasse to form a powdered sugar cane digestate and/or sugar cane vinasse.

In some embodiments, step (c), step (e) or both are required not optional. The size filtration, affinity filtration, evaporation, dilution and spray drying are as described elsewhere in relation to the fourth and alternate fourth aspects of the invention or in the detailed description and examples.

Preferably, the powdered sugar cane digestate and/or sugar cane vinasse is in accordance with the first or second aspects of the invention. Optionally, the sugar cane digestate and/or sugar cane vinasse of (a) has an odour intensity of 4-6 according to the VDI 3882-1 olfactometry standard, alternatively, 5-6, 4-6, 4, 5, or 6 according to the VDI 3882-1 olfactometry standard. Optionally, the filtered vinasse, digestate or vinasse digestate has no odour or an odour intensity of 0-3 according to the VDI 3882-1 olfactometry standard, alternatively, 0-2, 1-3, 1-2, 2-3, 0, 1, 2, or 3 according to the VDI 3882-1 olfactometry standard for measuring odour intensity.

In step (a), the sugar cane digestate and/or sugar cane vinasse is optionally 6-10 or 5-8 brix. Optionally, the sugar cane digestate and/or sugar cane vinasse is 500-1,500 mg GAE/100 g, 800-1,200 mg GAE/100 g or about 1,000 mg GAE/100 g.

In steps (b & (b2)), the solid or liquid sugar cane digestate and/or sugar cane vinasse is optionally diluted in water or a water based solution such as affination syrup or other sugar processing by-product such as molasses. Preferably, the solution or syrup used for dilution is low in reducing sugars (for example, less than 2%, 1%, 0.5% w/w reducing sugars) and/or includes polyphenols (for example, 100-1,500 mg GAE polyphenols/100 g).

In step (d), the affinity filter is optionally an activated carbon filter or an ion exchange resin. Optionally, the ion exchange resin is an anionic ion exchange resin. These filtering steps are as described above in relation to the fourth aspect of the invention or in the description and examples.

In an alternate fourth aspect, the present invention provides a method comprising:
(i) fermentation of sugarcane juice and/or sugarcane molasses;
(ii) distillation of the product of (i) to form a liquid polyphenol composition;
(iii) optionally anaerobic digestion of the product of (ii) (ie vinasse);
(iv) optionally filtration and/or concentration of the product of (iii) (ie vinasse digestate);
(v) optionally spray drying the product of (ii), (iii) and/or (iv) to form a powdered polyphenol composition.

In a further alternate fourth aspect, the present invention provides a method comprising:
(i) fermentation of sugarcane juice and/or sugarcane molasses;
(ii) distillation of the product of (i) to form a liquid polyphenol composition;
(iii) anaerobic digestion of the product of (ii) (ie vinasse);
(iv) optionally filtration and/or concentration of the product of (iii) (ie vinasse digestate);
(v) optionally spray drying the product of (iii) and/or (iv) to form a powdered polyphenol composition.

In embodiments of the alternate fourth aspects of the invention, step (iv) is required. In other embodiments, step (v) is required. Optionally step (iv) and step (v) are required. Optionally the product of step (ii), (iii) or (iv) is concentrated to about 30-50° Brix (preferably about 40° Brix) before spray drying.

Optionally, the filtration in (iv) is affinity filtration or both size filtration and affinity filtration.
Optionally, the affinity filtration is activated carbon filtration or ion-exchange resin filtration.

In some embodiments, the composition prepared in (ii), (iii) and/or (iv) is contacted with activated carbon as described in the fourth aspect of the invention and its embodiments. In other embodiments, the powdered composition of (iv) is dissolved in water and contacted with activated carbon as described in the fourth aspect of the invention and its embodiments. Where powdered polyphenol composition is dissolved and contacted with activated carbon it is optionally dried to powder again (eg spray dried).

Optionally, the product of (ii) and/or the product of (iii) has an odour intensity of 4-6 according to the VDI 3882-1 olfactometry standard. Alternatively, the product of (ii) and/or the product of (iii) has an odour intensity of 5-6, 4-6, 4, 5, or 6 according to the VDI 3882-1 olfactometry standard.

Optionally, the product of step (iii) and/or the powdered polyphenol composition of step (iv) has no odour or an odour intensity of 0-3 according to the VDI 3882-1 olfactometry standard. Alternatively, the product of step (iii) and/or the powdered polyphenol composition of step (iv) has an odour intensity of 0-2, 1-3, 1-2, 2-3, 0, 1, 2, or 3 according to the VDI 3882-1 olfactometry standard for measuring odour intensity.

In another alternate fourth aspect, the present invention provides a method comprising:
(i) fermentation of sugarcane juice and/or sugarcane molasses;
(ii) distillation of the product of (i) to form a liquid polyphenol composition;
(iii) optionally anaerobic digestion of the product of (ii) (ie vinasse);
(b) if required, diluting the product of (i) or (ii) to a viscosity suitable for filtration (eg 0-45 brix, 1-45 brix, 1-40 brix, 1-30 brix, 1-25 brix, 3-20 brix, 5-15 brix, 7-12 brix or about 10 brix)
(c) optionally size filtering the product of (iii) or (b) through a size filter to exclude particles above 500, 300, 200, 100, 50 microns;
(d) reducing the odour of sugar cane digestate and/or sugar cane vinasse through contacting with activated carbon or resin to produce a reduced odour sugar cane digestate and/or sugar cane vinasse, preferably contacting is via affinity filtering the sugar cane digestate and/or sugar cane vinasse through an affinity filter to produce an affinity filtered sugar cane digestate and/or sugar cane vinasse;
(e) optionally concentrating the filtered sugar cane digestate and/or sugar cane vinasse by evaporation to a viscosity suitable for spray drying (eg 20-60 brix, 30-50 brix, 35-45 brix, or about 40 brix) and then spray drying the filtered sugar cane digestate and/or sugar cane vinasse to prepare a powdered sugar cane digestate and/or sugar cane vinasse.

In another alternate fourth aspect, the present invention provides a method comprising:
(i) fermentation of sugarcane juice and/or sugarcane molasses;
(ii) distillation of the product of (i) to form a liquid polyphenol composition;
(iii) optionally anaerobic digestion of the product of (ii) (ie vinasse);
(b1) concentrating the product of (ii) ro (iii) (eg to 20-60 brix, 30-50 brix, 35-45 brix, or about 40 brix);
(b2) diluting the concentrated filtered sugar cane digestate and/or sugar cane vinasse to a viscosity suitable for filtration (eg 0-45 brix, 1-45 brix, 1-40 brix, 1-30 brix, 1-25 brix, 3-20 brix, 5-15 brix, 7-12 brix or about 10 brix)
(c) optionally size filtering the diluted sugar cane digestate and/or sugar cane vinasse through a size filter to exclude particles above 500, 300, 200, 100, 50 microns;
(d) reducing the odour of sugar cane digestate and/or sugar cane vinasse through contacting with activated carbon or resin to produce a reduced odour sugar cane digestate and/or sugar cane vinasse, preferably contacting is via affinity filtering the sugar cane digestate and/or sugar cane vinasse through an affinity filter to produce an affinity filtered sugar cane digestate and/or sugar cane vinasse;
(e) optionally concentrating the filtered sugar cane digestate and/or sugar cane vinasse to a viscosity suitable for spray drying (eg 20-60 brix, 30-50 brix, 35-45 brix, or about 40 brix);
(f) spray drying the filtered sugar cane digestate and/or sugar cane vinasse or concentrated sugar cane digestate and/or sugar cane vinasse to form a powdered sugar cane digestate and/or sugar cane vinasse.

In some embodiments, step (iii), step (c), step (e) or combinations thereof are required not optional. The details of the steps are as described above for other versions of the fourth and alternate fourth aspects of the invention.

The filtered sugar cane digestate and/or sugar cane vinasse and/or the powdered sugar cane digestate and/or sugar cane vinasse are optionally no or reduced odour as described above. Optionally, the powdered sugar cane digestate and/or sugar cane vinasse accords with aspects 1 or 2 of the invention.

In embodiments of the fourth and alternative fourth aspects of the invention comprising affinity filtration, the affinity filtration such as contact with activated carbon or resin results in a<50%, less than 40%, less than 30%, less than 20% (eg 5-40%, 5-30%, 10-30%, 5-20%, 10-20% or about 15%) reduction in polyphenols.

In embodiments of the fourth and alternative fourth aspects of the invention, the method does not include a solvent extraction step. Optionally, no organic and/or alcoholic solvent (eg ethanol) is added to the digestate/vinasse during the method. Optionally, the vinasse/digestate starting material is also not an extract.

In embodiments of the fourth and alternative fourth aspects of the invention, optionally, any insoluble fraction of the vinasse/digestate is removed before spray drying, for example, by size filtration.

In embodiments of the fourth and alternative fourth aspects of the invention, the spray dried vinase/digestate is optionally about 1,000 to about 20,000 mg GAE polyphenols/100 g, about 5,000 to about 15,000 mg GAE polyphenols/100 g, about 8,000 to about 12,000 mg GAE polyphenols/100 g, or about 10,000 mg GAE polyphenols/100 g.

In embodiments of the fourth and alternative fourth aspects of the invention, optionally dilution is in water or a water based solution such as affination syrup or other sugar processing by-product such as molasses. Preferably, the solution or syrup used for dilution is low in reducing sugars (for example, less than 2%, 1%, 0.5% w/w reducing sugars) and/or includes polyphenols (for example, 100-1,500 mg GAE polyphenols/100 g).

Sugars of the Invention

In a fifth aspect, the present invention provides a sugar comprising (i) one or more of sucrose, glucose and fructose and (ii) one or more of a sugar cane digestate and sugar cane vinasse. The sugar cane digestate and/or sugar cane vinasse are optionally as described in the first and second aspects of the invention and their embodiments. The sugar cane digestate and/or sugar cane vinasse are optionally prepared in accordance with the third or fourth aspects of the invention or their alternates, options or embodiments. Preferably, sugar cane vinasse and/or sugar cane digestate is sugar cane vinasse digestate. Optionally, the GI of the sugar of the invention is lower than the GI of the one or more of sucrose, glucose and fructose (ie the GI is lower than the GI of the ratio of sucrose, glucose and fructose in the sugar alone (without polyphenols)).

Optionally, the sugar is 80%, 85%, 90%, 95% or 99% sucrose, glucose and/or fructose. Optionally, the sugar has at least about 16 mg GAE polyphenols/100 g carbohydrate, at least about 25 mg GAE polyphenols/100 g carbohydrate, at least about 45 mg GAE polyphenols/100 g carbohydrate or at least about 55 mg GAE polyphenols/100 g carbohydrate. Alternatively, the sugar has at least about 5 mg GAE polyphenols/100 g carbohydrate, at least about 8 mg GAE polyphenols/100 g carbohydrate, at least about 10 mg GAE polyphenols/100 g carbohydrate or at least about 12 mg GAE polyphenols/100 g carbohydrate. Optionally, the sugar is less than 1 g GAE polyphenols/100 g carbohydrate. The sugar cane digestate and/or sugar cane vinasse is optionally 1-10 g per 100 g sugar by weight (ie 1-10%). Alternatively, the sugar cane digestate and/or sugar cane vinasse is 2-8% or 2-6% of the sugar by weight. The skilled person will understand that the amount of sugar cane digestate and/or sugar cane vinasse required depends on the amount of polyphenols desired for the sugar and the concentration of polyphenols in the sugar cane digestate and/or sugar cane vinasse.

The polyphenols in the sugar of the invention may be solely from the sugar cane digestate/sugar cane vinasse. Alternatively, the polyphenols in the sugars of the invention can be partially from the sugar cane digestate/sugar cane vinasse. In these sugars, the remaining polyphenols may be contained in the base sugar that is combined with the digestate/vinasse or added from an alternative source (for example, a sugar cane waste stream such as affination syrup or molasses or an extract of polyphenols from molasses). These polyphenols are preferably endogenous to sugar cane. The polyphenols preferably include flavonoids. Preferably, the polyphenols include one or more of tricin, luteolin and apigenin. Alternatively, the polyphenols include tricin. In some embodiments of the invention the amount of polyphenols in the sugar is about 37 mg GAE/100 g to about 80 mg GAE/100 g, about 38 mg GAE/100 g to about 70 mg GAE/100 g, about 39 mg GAE/100 g to about 60 mg GAE/100 g, about 40 mg GAE/100 g to about 55 mg GAE/100 g or about 45 mg GAE/100 g to about 55 mg CE/100 g carbohydrate. In preferred embodiments of the invention, the polyphenol content is about 45 mg GAE/100 g to about 55 mg GAE/100 g carbohydrate. In preferred embodiments, the polyphenol content is about 50 mg GAE/100 g carbohydrate. Preferably, the amount of polyphenols is effective to lower the GI of the sugar, for example, to a low glycaemic sugar. In alternative preferred embodiments of the invention, the amount of polyphenols in the sugar is about 5 mg GAE/100 g to about 35 mg GAE/100 g, about 8 mg GAE/100 g to about 30 mg GAE/100 g, about 10 mg GAE/100 g to about 20 mg GAE/100 g, about 12 mg GAE/100 g to about 18 mg GAE/100 g or about 8 mg GAE/100 g to about 12 mg GAE/100 g carbohydrate. Optionally, these sugars are medium glycaemic.

The sugars of the invention are preferred to have a glucose based glycaemic index of less than 45, optionally less than 30. Optionally, the glucose based glycaemic index is from about 5 to about 45, from about 5 to about 40, from about 5 to about 35, from about 5 to about 30, from about 5 to 25, from about 10 to about 30, from about 10 to about 35 or from about 10 to about 40. In preferred embodiments of the invention, the glucose based glycaemic index of the sugar particles is from about 10 to about 30.

In some embodiments, the sugar of the invention is crystalline. In alternate embodiments, the sugar of the invention is amorphous. Amorphous sugars of the invention may further include a drying agent to improve the stability of the amorphous sugar. Drying agents are about 200 g/mol to about 70 kDa. About 5% to about 60% w/w drying agent is usually effective. Suitable drying agents include cake flour, cinnamon powder, cocoa powder, coconut powder, vanilla powder, pea/soy/oat/egg (including egg white)/celery/rice/sunflower protein powder, wheat germ, sugar beet pulp, bagasse or sugar cane pulp powder. Preferred density lowering agents are selected from the group consisting of whey protein isolate, sunflower protein, pea protein, egg white protein or combinations thereof. Suitable digestion resistant density lowering agents include vitreous fibre, wheat bran fibre, wheat germ, sugar beet or sugar cane pulp, bagasse or combinations thereof. Further details are provided in international patent application PCT/SG2019/050057 and Singapore patent specification number 10201902102Q.

In an embodiment of the fifth aspect, the sugar is at least about 80% w/w sucrose and low glycaemic or very low glycaemic. Optionally, the sugar is 85%, 90%, 95% or 99% sucrose. Optionally, the sugar has at least about 16 mg GAE polyphenols/100 g carbohydrate, at least about 25 mg GAE polyphenols/100 g carbohydrate, at least about 45 mg GAE polyphenols/100 g carbohydrate or at least about 55 mg GAE polyphenols/100 g carbohydrate. Alternatively, the sugar has at least about 5 mg GAE polyphenols/100 g carbohydrate, at least about 8 mg GAE polyphenols/100 g carbohydrate, at least about 10 mg GAE polyphenols/100 g carbohydrate or at least about 12 mg GAE polyphenols/100 g carbohydrate. Optionally, the sugar has less than 1 g GAE polyphenols/100 g carbohydrates or less than 100 mg GAE polyphenols/100 g carbohydrate. Optionally, the sugar has about 37 mg GAE polyphenols/100 g carbohydrate to about 80 mg GAE polyphenols/100 g carbohydrate. Optionally, the sugar has 0 to 1.5% w/w reducing sugars, wherein the sugar is not more than 0.5% w/w fructose and not more than 1% w/w glucose. In alternative preferred embodiments of the invention, the amount of polyphenols in the sugar is about 5 mg GAE/100 g to about 35 mg GAE/100 g, about 8 mg GAE/100 g to about 30 mg GAE/100 g, about 10 mg GAE/100 g to about 20 mg GAE/100 g, about 12 mg GAE/100 g to about 18 mg GAE/100 g or about 8 mg GAE/100 g to about 12 mg GAE/100 g carbohydrate. Optionally, these sugars are medium glycaemic.

In some embodiments, the sucrose sugar of the invention further comprises reducing sugars. Optionally, the reducing sugar content of the sugar is about 0.001% to 1.5%, 0.001% to 1.2%, 0.001% to 1%, 0 to 0.6%, 0.001% to 0.5%, 0 to 0.3%, 0.001% to 0.2%, 0 to 0.15%, 0.001% to 0.15%, 0.01 to 0.1% w/w of the sugar. Optionally, the reducing sugars are glucose and fructose. Optionally, the glucose to fructose ratio is 0.8 to 1.2. Optionally, the reducing sugar content is not more than 50% glucose. In preferred embodiments, the quantity of fructose is not more than 0.5% w/w or 0.3% w/w of the sugar.

It is also preferred that the sucrose sugar of the invention has low hygroscopicity. Low hygroscopicity is useful for industrial processing because it allows the sugar to be handled by industrial equipment in an unaltered atmosphere (ie not under nitrogen) without significant clumping or sticking to the equipment. If a sugar is too hygroscopic, it is difficult to use that sugar industrially in the production of foods and beverages. Low hygroscopicity is also likely to improve the shelf life of the sugar product. Without being bound by theory, it is thought that sugar particles of the invention have lower hygroscopicity than previous low GI sugars because they have lower reducing sugar content. Preferred sugars of the invention have 0 to 0.5% w/w, 0 to 0.3% w/w or 0 to 0.15% w/w of the hygroscopic reducing sugar fructose.

It is preferred that the sucrose sugars of the invention have low levels of the high GI sugar glucose. Preferred sugars of the invention have 0 to 1% w/w, 0 to 0.5% w/w, 0 to 0.3% w/w or 0 to 0.15% w/w of the high GI sugar glucose.

Optionally, the sucrose sugar of the invention comprises 0 to 1% w/w reducing sugars of which 0 to 0.5% w/w is fructose and 0 to 0.5% w/w is glucose. Alternatively, the sugar of the invention comprises 0 to 1.5% w/w reducing sugars of which 0 to 0.5% w/w is fructose and 0 to 1% w/w is glucose. Alternatively, the sugar of the invention comprises 0 to 0.6% w/w reducing sugars of which 0 to 0.3% w/w is fructose and 0 to 0.3% w/w is glucose.

In some embodiments of the present invention, the sugar is 85% or more w/w sucrose, 90% or more w/w sucrose, 95% or more w/w sucrose. Alternatively, the sugar is 98% or more w/w sucrose. Alternatively, the sugar is 99% or more w/w sucrose.

In some embodiments, the sugar of the present invention has a moisture content of 0.02% to 0.6%, 0.02 to 0.3%, 0.02% to 0.2%, 0.1% to 0.5%, 0.1% to 0.4%, 0.1 to 0.2%, 0.2% to 0.3% or 0.3 to 0.4% w/w. Alternatively, the moisture content is 0.02 to 0.5% w/w.

It is preferred that the sugar particles have moisture content as described above when they are manufactured and have 0.02% to 1%, 0.02% to 0.8%, 0.02% to 0.6%, 0.1% to 0.5%, 0.1% to 0.4% or 0.2% to 0.3% w/w moisture content after 6 months storage at room temperature and 40% relative humidity or, alternatively, after 12 months storage at room temperature and 40% relative humidity. Alternatively, the increase in moisture content of the sugar particles is a maximum of 0.3% over the 2 year shelf life for the sugar particles. The sugar particles of the invention retain the above low moisture content after storage because of their low hygroscopicity. Without being bound by theory, the lower hygroscopicity is thought to be a result of the low reducing sugar content (in particular the fructose content) of the sugar particles of the invention.

The sugar of the invention is preferably food grade.

The sugars of the invention are solids. However, syrup and liquid sugars are also contemplated. In liquid or syrup versions of the sugar of the invention the amount of sucrose is measured by solid weight and equivalent to the w/w % amounts for the solid sugars of the invention. Syrup and liquid versions of the sugars of the invention can be prepared by the addition of solvents such as water to the sugars of the invention. It is also possible to prepare a liquid or syrup sugar composition with the sucrose and polyphenol quantities described for the solid sugars of the invention and optionally the reducing sugar, glucose, and fructose levels described for the solid sugars of the invention. These are liquid or syrup sugars of the invention.

Optionally, the solid sugars of the invention are free flowing crystalline and/or amorphous solids.

Foods and Beverages

In a sixth aspect, the present invention provides a food or beverage comprising one or more sugars of the present invention and/or one or more polyphenol compositions of the invention.

In an alternate sixth aspect, the present invention provides a food or beverage comprising one or more sugars selected from sucrose, glucose and/or fructose; and one or more of sugar cane digestate and sugar cane vinasse, wherein the sugar and sugar cane digestate/sugar cane vinasse are either added to the food or beverage in the form of a sugar of the invention or separately such that the polyphenols are equivalent to about 16 mg GAE polyphenols/100 g sugar to about 80 mg GAE polyphenols/100 g sugar or the other polyphenol amounts for sugars of the invention. The amount of polyphenol to sucrose can be determined, even where there are other carbohydrate present in the food or beverage, indirectly from the amounts of polyphenols and the amounts of sugar in the food or beverage.

In a seventh aspect, the present invention provides a method of preparing a food or beverage comprising combining one or more sugar of the present invention and/or one or more polyphenol compositions of the invention with one or more ingredients suitable for consumption.

In embodiments of the sixth, alternate sixth and seventh aspects of the invention, suitable foods include bread, cereal, chocolate and confectionary. Alternatively, suitable foods include baked goods such as bread, biscuits and cake, cereal, chocolate, confectionary, and dried fruit. Suitable beverages include fruit juices, tea-based drinks, milk-based drinks, soy milk-based drinks, nut juice-based drinks (eg almond milk) and soft drinks. Optionally, the food or beverage is for human consumption. Alternatively, the food or beverage is for animal consumption, for example, the food is optionally animal feed as described below.

In an eighth aspect, the present invention provides an animal feed comprising one or more sugars of the present invention and/or one or more polyphenol compositions of the invention. In an alternate eight aspect, the invention provides a method of feeding an animal comprising addition of one or more sugars of the present invention and/or one or more polyphenol compositions of the invention to the animals feed or feeding the animal a feed including one or more sugars of the present invention and/or one or more polyphenol compositions of the invention.

In the sixth, alternate sixth, seventh and eighth aspects of the invention, examples of animals include aquatic animals, amphibians, insects, invertebrates, birds, reptiles, monogastric animals, ruminants and pseudo-ruminants. Animals propagated in agriculture, animals propagated in aquaculture and companion animals are preferred. Animals propagated in agriculture are particularly preferred. Insects and invertebrates are also preferred, particularly insects and invertebrates suitable for use as a feedstock for animals propagated in agriculture, animals propagated in aquaculture and companion animals. Insects and invertebrates suitable for use as a feedstock for poultry (particularly chickens and ducks) and finfish (particularly, salmon, tuna and trout) are particularly preferred. Insects suitable for use as a feedstock for poultry (particularly chickens and ducks) and finfish (particularly, salmon, tuna and trout) are particularly preferred.

Optionally, aquatic animals include finfish (particularly salmon, trout and tuna), shellfish (particularly, crabs, crayfish, lobsters, prawns and shrimp), and molluscs (particularly mussels, oysters and scallops). In one embodiment, the animal feed is suitable for salmon. In one embodiment, the animal feed is suitable for tuna. Optionally, amphibians include frogs. Optionally, insects include beetles, grasshoppers, butterflies, moths, flies, crickets and dragonflies (particularly the larval stage of the insect, for instance grubs, maggots, mealworms, mudeyes etc). In one embodiment, the animal feed is suitable for mealworms. Optionally, invertebrates include annelids (particularly earthworms and marine worms such as beach worms). In one embodiment, the animal feed is suitable for earthworms. Optionally, birds includes poultry (particularly chickens, ducks, geese, turkeys and quails), parrots, and raptors. In one embodiment, the animal feed is chicken feed. In one embodiment, the animal feed is duck feed. Optionally, reptiles include alligators, crocodiles, lizards, and snakes. Optionally, monogastric animals include cats, dogs, pigs, and rodents (particularly mice, rats and guinea pigs). Optionally ruminants include cattle, sheep, goats, and deer. In one embodiment, the animal feed is suitable for cattle. In one embodiment, the animal feed is suitable for beef cattle. In one embodiment, the animal feed is suitable for dairy cattle. In one embodiment, the animal feed is suitable for sheep. Preferred pseudo-ruminants include horses, camels and rabbits. In one embodiment, the animal feed is suitable for horses.

In some embodiments, the animal feed is a powder. In some embodiments, the animal feed is a liquid. In some embodiments, the animal feed is a component of a solid animal feed composition, for instance, a pellet. In some embodiments, the component of the animal feed composition coats granules or pellets of the bulk composition, or is substantially uniformly mixed throughout the feed.

Preparing Sugars of the Invention

In a ninth aspect, the present invention provides a method comprising addition of an additive comprising sugar cane vinasse and/or sugar cane digestate to a first sugar to produce a second sugar, wherein:

the first sugar comprises

about 0 to about 65 mg GAE polyphenols/100 g carbohydrate and 0 to 1.5% w/w reducing sugar; and

the second sugar comprises about 16 mg GAE polyphenols/100 g carbohydrate to about 80 mg GAE polyphenols/100 g carbohydrate and 0 to 1% w/w reducing sugar. Alternatively, the second sugar comprises about 5 mg GAE polyphenols/100 g carbohydrate to about 80 mg GAE polyphenols/100 g carbohydrate.

The additive may be added in either powder or liquid form. Optionally, the addition of the additive is by a spray process. The first sugar is optionally a sucrose sugar such as a cane sugar or a beet sugar. The first sugar can also be a partially refined sugar prepared by a primary sugar mill. The skilled person can determine the amount of polyphenol content in the first sugar and then determine the concentration of polyphenol in the additive and the amount of additive necessary to prepare the second sugar. The additive is optionally less than 5%, less than 3%, less than 2% or less than 1% sugar.

In an alternative ninth aspect, the present invention provides a method for preparing a second sugar comprising:

(i) washing sugar cane massecuite or an unrefined sugar including sucrose crystals, polyphenols and reducing sugars to remove an amount of polyphenols and an amount of reducing sugars from the massecuite and produce a first sugar; and

(ii) addition of an additive comprising sugar cane vinasse and/or sugar cane digestate to the first sugar to prepare the second sugar;

wherein the first sugar comprises about 0 to 1% w/w reducing sugars and optionally about 0 to about 65 mg GAE polyphenols/100 g carbohydrate and the second sugar comprises about 37 mg GAE polyphenols/100 g carbohydrate to about 80 mg GAE polyphenols/100 g carbohydrate and 0 to 1% w/w reducing sugar. Optionally, the second sugar is low glycaemic or very low glycaemic. Optionally, the second sugar has a GI of 45 or less. Alternatively, the second sugar comprises about 5 mg GAE polyphenols/100 g carbohydrate to about 80 mg GAE polyphenols/100 g carbohydrate. Alternatively, the second sugar is medium glycaemic.

In a further alternate ninth aspect, the present invention provides a method for preparing a second sugar comprising:

washing with an additive comprising sugar cane vinasse and/or sugar cane digestate a first sugar to prepare the second sugar, such that the second sugar has a lower amount of reducing sugars,
wherein the first sugar is sugar cane massecuite or an unrefined sugar including sucrose crystals, polyphenols and reducing sugars;

wherein the first sugar comprises about 0 to 1% w/w reducing sugars and optionally about 0 to about 65 mg GAE polyphenols/100 g carbohydrate and the second sugar comprises about 37 mg GAE polyphenols/100 g carbohydrate to about 80 mg GAE polyphenols/100 g carbohydrate and 0 to 1% w/w reducing sugar. Optionally, the second sugar is low glycaemic or very low glycaemic. Optionally, the second sugar has a GI of 45 or less. Alternatively, the second sugar comprises about 5 mg GAE polyphenols/100 g carbohydrate to about 80 mg GAE polyphenols/100 g carbohydrate. Alternatively, the second sugar is medium glycaemic.

Optionally, the second sugar in the ninth and alternate ninth aspects of the invention is a sugar of the fifth aspect of the invention, its alternates, options or embodiments. The sugar cane vinasse and/or sugar cane digestate may be in the form of a polyphenol composition of the first or second aspect of the invention, their alteratives or their embodiments.

In some embodiments of the ninth and alternate ninth aspects of the invention, the first sugar does not contain significant polyphenols (eg about 0 to 1 mg GAE/100 g) or reducing sugars (eg about 0 to 0.01% w/w) (ie it was washed and otherwise refined to white refined sugar before the addition of the additive). Alternatively, the first sugar has 0-35 mg GAE polyphenols/100 g carbohydrate. In some embodiments, the first sugar has about 0 polyphenol content. In alternate embodiments the first sugar has about 10 to about 65 mg GAE polyphenols/100 g carbohydrate. In some embodiments, the first sugar is low glycaemic. Optionally, the first sugar is 0 to 1.5 (or 0.1-1.5% or 0.1-1%) w/w reducing sugar. Alternatively, the first sugar is medium glycaemic. Optionally, the first sugar is a mill sugar, an industrial raw sugar or an industrial brown sugar. Optionally, the first sugar is prepared in a sugar refinery.

In some embodiments of the ninth and alternate ninth aspects of the invention, the sugar is ≥80%, ≥85%, ≥90%, ≥95% or ≥99% sucrose.

In some embodiments of the ninth and alternate ninth aspects of the invention, the second sugar comprises about 37 mg GAE polyphenols/100 g carbohydrate to about 80 mg GAE polyphenols/100 g carbohydrate. In these embodiments, there is optionally about 0 to 0.8 or 0 to 0.6% reducing sugars by weight. Alternatively, the second sugar includes about 16 mg GAE polyphenols/100 g carbohydrate to about 37 mg GAE polyphenols/100 g carbohydrate. In this embodiment, the second sugar optionally includes about 0 to 0.4 or 0 to 0.2% reducing sugars by weight. Alternatively, the second sugar comprises about 5 mg GAE polyphenols/100 g carbohydrate to about 35 mg GAE polyphenols/100 g carbohydrate. In this embodiment, the second sugar optionally has 0 to 1.5 (or 0.1-1.5% or 0.1-1%) w/w reducing sugar.

In some embodiments of the ninth and alternate ninth aspects of the invention, the second sugar comprises at least 29 mg GAE polyphenols/100 g carbohydrate. In this embodiment, the second sugar optionally includes less than 45 mg GAE polyphenols/100 g carbohydrates and/or less than 0.2% reducing sugars by weight. In alternate embodiments of the ninth and alternate ninth aspects of the invention, the second sugar comprises at least 45 mg GAE polyphenols/100 g carbohydrate. In this embodiment, the second sugar optionally includes less than 80 mg GAE polyphenols/100 g carbohydrates and/or less than 0.4% reducing sugars by weight. In some embodiments of the ninth and alternate ninth aspects of the invention, the second sugar comprises at least 5 mg GAE polyphenols/100 g carbohydrate. In this embodiment, the second sugar optionally includes less than 35 mg GAE polyphenols/100 g carbohydrates and/or less than 1.5% reducing sugars by weight. Optionally, the second sugar is a sugar according to the third or fourth aspect of invention, their alternatives, their options or their embodiments.

In some embodiments of the ninth and alternate ninth aspects of the invention, the additive is at least 80%, 85%, 90%, 95%, or 99% sugar cane digestate and/or sugar cane vinasse by solid weight. In some embodiments, the additive includes molasses and sugar cane digestate and/or sugar cane vinasse. Where molasses is included in the additive, it is optionally treated with glucose oxidase to minimise the glucose content before its use in the preparation of the second sugar. Optionally, the additive is a polyphenol composition of the first or second aspect of the invention, their alternatives, their options or their embodiments. Optionally, the additive is a solid or powdered polyphenol composition of the first or second aspect of the invention, their alternatives, their options or their embodiments that has been dissolved in water or a sugar cane waste stream such as affination syrup or molasses.

In some embodiments of the ninth and alternate ninth aspects of the invention, the method further comprises addition of a second additive to the first sugar. Optionally, the second additive comprises polyphenols. Optionally, the second additive is a known polyphenol source such as a product derived from a sugar cane waste stream. Suitable options include molasses, dunder, and extracts of these.

In embodiments of the ninth and alternative ninth aspects of the invention involving a massecuite wash, the massecuite has 160-330 mg GAE polyphenols/100 g carbohydrate. In preferred embodiments, the massecuite has 190-260 mg CE polyphenols/100 g carbohydrate. In some embodiments of the invention, washing the massecuite removes 130-310 mg CE polyphenols/100 g carbohydrate. In preferred embodiments, washing the massecuite removes 180-250 mg CE polyphenols/100 g carbohydrate.

In a tenth aspect, the present invention provides a method including:
(i) fermentation of sugarcane juice and/or sugarcane molasses;
(ii) distillation of the product of (i) to form a liquid polyphenol composition (ie vinasse);
(iii) optionally anaerobic digestion of the composition of (ii)
(iv) optionally filtration and/or concentration of the product of (ii) or (iii);
(v) optionally spray drying to form a powdered polyphenol composition;
(vi) optionally reconstituting the powdered polyphenol composition with water and/or affination syrup;
(vii) combining the product of (ii), (iii), (iv), (v) and/or (vi) with a sugar.

In an alternate tenth aspect, the present invention provides a method including:
(i) fermentation of sugarcane juice and/or sugarcane molasses;
(ii) distillation of the product of (i) to form a liquid polyphenol composition (ie vinasse);
(iii) anaerobic digestion of the composition of (ii)
(iv) optionally filtration and/or concentration of the product of (ii) or (iii);
(v) optionally spray drying to form a powdered polyphenol composition;
(vi) optionally reconstituting the powdered polyphenol composition with water and/or affination syrup;
(vii) combining the product of (ii), (iii), (iv), (v) and/or (vi) with a sugar.

In embodiments of the alternate and further alternate tenth aspects of the invention, step (iv) is required. In other embodiments, step (v) is required. Optionally, both steps (iv) and (v) are required. Optionally, the product of step (ii), (iii) or (iv) is concentrated to about 30-50° Brix (preferably about 40° Brix) before spray drying.

In some embodiments, the composition prepared in (ii), (iii) and/or (iv) is contacted with activated carbon as described in the fourth aspect of the invention and its embodiments. In other embodiments, the powdered composition of (iv) is dissolved in water and contacted with activated carbon as described in the fourth aspect of the invention and its embodiments. Where powdered polyphenol composition is dissolved and contacted with activated carbon it is optionally dried to powder again (eg spray dried).

In some embodiments, the polyphenol composition product of (ii), (iii), (iv), (v) and/or (vi) is combined with a crystalline sugar by spraying onto said crystalline sugar. In alternative embodiments, the polyphenol composition product of (ii), (iii), (iv), (v) and/or (vi) is combined is combined with a liquid containing sugar (eg one or more of sugar cane juice or sugar beet juice or molasses) and rapid drying (eg spray drying) to form an amorphous sugar. Optionally, a drying agent is added to the liquid for spray drying. The drying agent is optionally as described in the embodiments of the fifth aspect of the invention.

Optionally, the sugar is a sugar of this invention according to aspect 5 of the invention and its embodiments. Optionally, the polyphenol composition is a polyphenol composition according to aspects 1 and 2 of the invention and their embodiments.

In an another alternate tenth aspect, the present invention provides a method comprising:
(i) fermentation of sugarcane juice and/or sugarcane molasses;
(ii) distillation of the product of (i) to form a liquid polyphenol composition;
(iii) optionally anaerobic digestion of the product of (ii) (ie vinasse);
(b) if required, diluting the product of (i) or (ii) to a viscosity suitable for filtration (eg 0-45 brix, 1-45 brix, 1-40 brix, 1-30 brix, 1-25 brix, 3-20 brix, 5-15 brix, 7-12 brix or about 10 brix)
(c) optionally size filtering the product of (iii) or (b) through a size filter to exclude particles above 500, 300, 200, 100, 50 microns;
(d) reducing the odour of sugar cane digestate and/or sugar cane vinasse through contacting with activated carbon or resin to produce a reduced odour sugar cane digestate and/or sugar cane vinasse, preferably contacting is via affinity filtering the sugar cane digestate and/or sugar cane vinasse through an affinity filter to produce an affinity filtered sugar cane digestate and/or sugar cane vinasse;
(e) optionally concentrating the filtered sugar cane digestate and/or sugar cane vinasse by evaporation to a viscosity suitable for spray drying (eg 20-60 brix, 30-50 brix, 35-45 brix, or about 40 brix) and then spray drying the filtered sugar cane digestate and/or sugar cane vinasse to prepare a powdered sugar cane digestate and/or sugar cane vinasse; and
(f) combining the product of (d), (e) or combinations thereof with a sugar.

In another alternate tenth aspect, the present invention provides a method comprising:
(i) fermentation of sugarcane juice and/or sugarcane molasses;
(ii) distillation of the product of (i) to form a liquid polyphenol composition;
(iii) optionally anaerobic digestion of the product of (ii) (ie vinasse);
   (b1) concentrating the sugar cane digestate and/or sugar cane vinasse by evaporation (eg to 20-60 brix, 30-50 brix, 35-45 brix, or about 40 brix);
   (b2) diluting the concentrated filtered sugar cane digestate and/or sugar cane vinasse to a viscosity suitable for filtration (eg 0-45 brix, 1-45 brix, 1-40 brix, 1-30 brix, 1-25 brix, 3-20 brix, 5-15 brix, 7-12 brix or about 10 brix)
   (c) optionally size filtering the sugar cane digestate and/or sugar cane vinasse through a size filter to exclude particles above 500, 300, 200, 100, 50 microns;
   (d) reducing the odour of sugar cane digestate and/or sugar cane vinasse through contacting with activated carbon or resin to produce a reduced odour sugar cane digestate and/or sugar cane vinasse, preferably contacting is via affinity filtering the sugar cane digestate and/or sugar cane vinasse through an affinity filter to produce an affinity filtered sugar cane digestate and/or sugar cane vinasse;
   (e) optionally concentrating the filtered sugar cane digestate and/or sugar cane vinasse to a viscosity suitable for spray drying (eg 20-60 brix, 30-50 brix, 35-45 brix, or about 40 brix);
   (f) spray drying the filtered sugar cane digestate and/or sugar cane vinasse to form a powdered sugar cane digestate and/or sugar cane vinasse;
   (g) combining the product of (b1), (d), (e), (f) or combinations thereof with a sugar.

In some embodiments, step (iii), step (c), step (e) or combinations thereof are required not optional. The filtered sugar cane digestate and/or sugar cane vinasse and/or the powdered sugar cane digestate and/or sugar cane vinasse are optionally no or reduced odour as described above.

The details of the steps are as described above for other versions of the fourth and alternate fourth aspects of the invention.

Optionally, the sugar is a sugar of this invention according to aspect 5 of the invention and its embodiments. Optionally, the polyphenol composition is a polyphenol composition according to aspects 1 and 2 of the invention and their embodiments.

In embodiments of the tenth and alternative tenth aspects of the invention, the method does not include a solvent extraction step. Optionally, no organic and/or alcoholic solvent (eg ethanol) is added to the digestate/vinasse during the method. Optionally, the vinasse/digestate starting material is also not an extract.

In embodiments of the tenth and alternative tenth aspects of the invention, optionally, any insoluble fraction of the vinasse/digestate is removed before spray drying, for example, by size filtration.

Feedstock for preparing polyphenol compositions, starting material for methods of aspects 3 and 4 of the invention and their alternatives, options or embodiments, and vinasse/digestates prepared in aspect 10 of the invention and its alternatives, options or embodiments.

The sugar cane vinasse is optionally formed during preparation of bioethanol, rum, amino/organic acid (eg ascorbic acid), yeast propagation or a combination thereof. Preferably, the vinasse is formed during preparation of ethanol such as bioethanol or rum. Preferably, the digestate is anaerobic digestate.

In all aspects of the invention, optionally, the feedstock from which the vinasse or digestate is prepared is sugarcane juice, massecuite, molasses or brown/raw sugar cane sugar. Sugarcane juice and molasses are preferred feed stocks for vinasse. Sugar cane vinasse can also be the feedstock for digestate. Preferably, sugar cane vinasse and/or sugar cane digestate is sugar cane vinasse digestate. More preferably, the sugar cane vinasse digestate is sugar juice vinasse digestate and/or molasses vinasse digestate. Preferably, the feedstock has 500-5,000 mg GAE/100 g polyphenols. More preferably, the feedstock has 500-1,000 mg GAE/100 g polyphenols, for example about 800 mg GAE/100 g polyphenols.

Optionally, the sugar cane vinasse or sugar cane digestate is not an extract. Optionally, the sugar cane vinasse or sugar cane digestate is a filtrate, preferably an affinity filtration filtrate such as an activated carbon filtrate and/or an ion-exchange resin filtrate.

Optionally, the solid sugars produced by the ninth and tenth aspects of the invention and their alternatives, embodiments and options are free flowing crystalline and/or amorphous solids.

Further aspects of the present invention and further embodiments of the aspects described in the preceding paragraphs will become apparent from the following description, given by way of example and with reference to the accompanying drawings.

It will be understood that the invention disclosed and defined in this specification extends to all alternative combinations of two or more of the individual features mentioned or evident from the text or drawings. All of these different combinations constitute various alternative aspects of the invention.

### BRIEF DESCRIPTION OF THE DRAWINGS

FIG. 1 depicts the GI of several of the samples prepared in Example 6.

### DETAILED DESCRIPTION OF THE EMBODIMENTS

Reference will now be made in detail to certain embodiments of the invention. While the invention will be described in conjunction with the embodiments, it will be understood that the intention is not to limit the invention to those embodiments. On the contrary, the invention is intended to cover all alternatives, modifications, and equivalents, which may be included within the scope of the present invention as defined by the claims.

Further aspects of the present invention and further embodiments of the aspects described in the preceding paragraphs will become apparent from the following description, given by way of example.

All of the patents and publications referred to herein are incorporated by reference in their entirety.

For purposes of interpreting this specification, terms used in the singular will also include the plural and vice versa.

One skilled in the art will recognize many methods and materials similar or equivalent to those described herein, which could be used in the practice of the present invention. The present invention is in no way limited to the methods and materials described.

The inventors of the present invention have developed a high concentration polyphenol composition and methods for its production. The polyphenol composition is high concentration and low odour. The composition is prepared from byproducts of the sugar cane industry and from ethanol from sugar cane or products sourced from sugar cane. There are environmental advantages to the repurpose of these byproducts in the minimisation of difficult to dispose waste and increasing the renewability of resources.

The odour reduction of the compositions of the invention is the result of affinity removal of an organic fraction via carbon or resin. There are environmental advantages to processes that do not require an extraction step such as minimising waste by avoiding the use of large quantities of additional solvents including ethanol and requiring less infrastructure to perform the process.

The polyphenol composition, vinasse or digestate are used to add polyphenols to polyphenol containing sugar products. These sugars (particularly sucrose sugars) are either crystalline or amorphous and are healthier than traditional white sucrose sugar. Some of these sugars are described in International patent specification numbers PCT/SG2019/050416 and PCT/SG2019/050057 and Singapore patent specification number 10201902102Q. Processes for preparing these sugars is described in these specifications and also in International patent specification numbers PCT/SG2019/050377.

It will be understood that various terms employed in the specification, examples and claims have meanings that will be understood by one of ordinary skill in the art. However, certain terms are defined below.

As used herein, except where the context requires otherwise, the term “comprise” and variations of the term, such as “comprising”, “comprises” and “comprised”, are not intended to exclude further additives, components, integers or steps.

The term “affination syrup” refers to a syrup used at a sugar refinery in the preparation of affined sugar. Raw sugar and water are combined, slowly agitated and heated (eg up to 45° C.) to soften the raw sugar syrup layer. This is then centrifuged. Syrup passes through the centrifuge screens and the sugar crystals (affined sugar) remain behind. The crystals are washed with water and that water often combined with the syrup to form affination syrup, which is heated (eg to about 76° C.) before combination with a new batch of raw sugar.

The term “amorphous” refers to a solid that is largely amorphous, that is, largely without crystalline structure. For example, the solid could be 80% or more amorphous, 90% or more amorphous, 95% or more amorphous or about 100% amorphous.

Amorphous sugars can be prepared as described in Singapore patent specification number 10201902102Q.

The term “anaerobic” refers to something living, active, occurring, or existing in the absence of free oxygen. For example, an anaerobic digestate is a digestate prepare in anaerobic conditions by anaerobic microorganisms.

The term “bagasse” refers to sugar fibre either from sugar cane or sugar beet. It is the fibrous pulp left over after sugar juice is extracted. Bagasse products are commercially available, for example, Phytocel is a sugar cane bagasse product sold by KFSU.

The term “Biochemical Oxygen Demand” (BOD) is a measure of the amount of food (or organic carbons) that bacteria can oxidize. BOD (biochemical oxygen demand) indicates the amount of biodegradable matter in effluent.

The term “brown sugar” refers to a food grade sugar of brown colour.

The term “chemical oxygen demand” (COD) is an indicative measure of the amount of oxygen that can be consumed by reactions in a measured solution. It is the total measurement of all chemicals in the water that can be oxidized but provides no information on their biodegradability.

The terms “efficacious” or “effective amount” refer to an amount that is biologically or chemically effective. In this context, one example is an effective amount of polyphenols in a sugar product to achieve a low glycaemic sugar.

The term “endogenous” refers to something originating from within an organism. In the context of the present invention, it refers to something originating from within sugar cane, for example, a phytochemical including monophenol or polyphenol and polysaccharide can be endogenous because the compound originated from within the sugar cane.

The term “extract” refers to a composition extracted or removed from something else. For example, an extract can be prepared by solubilising a soluble fraction from an original product into an extraction solvent. An extract can also be prepared by precipitating an insoluble fraction from an original product out of an extraction solvent. The extract is a product of combining the original product (usually plant based material) and extraction solvent (commonly ethanol). The fraction of the original product is solubilised into the extraction solvent to form a supernatant, the supernatant is separated from the remnants of the original product, and removed with the extraction solvent. The extract is the supernatant including the solubilised portion in the extraction solvent, or a concentrate or dried version thereof. The remnants of the original product, such as plant matter, left behind and/or precipitated following extraction is not an extract.

The term “filtrate” refers to a composition that has been filtered, for example, by size or affinity filtration.

The term “food grade” refers to products suitable for human consumption including products suitable for combination with other products to prepare a food.

The term “high glycaemic” refers to a food with a glucose based GI of 70 or more.

The term “low glycaemic” refers to a food with a glucose based GI of 55 or less.

The term “massecuite” refers to a dense suspension of sugar crystals in the mother liquor of sugar syrup. This is the suspension that remains after concentration of the sugar juice into a syrup by evaporation, crystallisation of the sugar and removal of molasses.

The massecuite is the product that is washed in a centrifuge to prepare bulk sugar crystals.

The term “medium glycaemic” refers to a food with a glucose based GI of 56 to 69.

The term “odourless” refers to no discernible odour. In particular, odour is not discerned by a human in close proximity (eg 10 cm away).

The term “prebiotic” refers to a food ingredient that stimulates the growth and/or activity of one or more beneficial gastrointestinal bacteria. Prebiotics may be non-digestible foods or of low digestibility. A prebiotic can be a fibre but not all fibres are prebiotic. Oligosaccharides with a low degree of polymerisation ie are thought to better stimulate bacteria concentration than oligosaccharides with higher degree of polymerisation.

The term “phytochemical” refers generally to biologically active compounds that occur naturally in plants.

The term “polyphenol” refers to chemical compounds that have more than one phenol group. There are many naturally occurring polyphenols and many are phytochemicals. Flavonoids are a class of polyphenols. Polyphenols including flavonoids naturally occur in sugar cane. In the context of the present invention the polyphenols that naturally occur in sugar cane are most relevant. Polyphenols in food are micronutrients that are of interest because of the role they are currently thought to have in prevention of degenerative diseases such as cancer, cardiovascular disease or diabetes.

The term “raw sugar” refers to a food grade sugar of light brown colour.

The term “reduced” refers to an amount lower than a reference amount. Reduced odour can be an odour lower than the previous odour of a specific sample of vinasse and/or digestate. Alternatively, the reduced odour can be lower than the usual odour for the vinasse and/or digestate. A polyphenol composition (ie vinasse or digestate of the invention) has a reduced odour when there is no odour following combining the polyphenol composition with white refined sucrose or raw mill sugar to produce a 10, 15, 20, 30, 40 or 50 mg GAE polyphenol/100 g carbohydrate sugar/polyphenol blend.

The term “reducing sugar” refers to any sugar that is capable of acting as a reducing agent. Generally, reducing sugars have a free aldehyde or free ketone group. Glucose, galactose, fructose, lactose and maltose are reducing sugars. Sucrose and trehalose are not reducing sugars.

The term “refined white sugar” refers to fully processed food grade white sugar that is essentially sucrose with minimal reducing sugar content and minimal phytochemicals such as polyphenols or flavonoids.

The term “sugar” refers to a solid, the majority of which is sucrose, glucose or fructose (ie a sucrose sugar could be 80%, 90%, 95%, 99% w/w sucrose). The sugar may contain one or more other low molecular weight sugars. The sugar may be solid or liquid. Solid sugar may be crystalline or amorphous. The sugar may contain other ingredients such as polyphenols and various minerals. Common sucrose sugars are prepared from sugar cane or from sugar beet.

The term “sugar cane digestate” refers to digestate containing sugar cane polyphenols. The digestate can be prepared from a feed stock ultimately sourced from sugar cane such as sugar cane juice, sugar cane molasses, massecuite, raw or brown sugar cane, or sugar cane vinasse. Sugar cane vinasse is preferred.

The term “sugar cane vinasse” refers to vinasse containing sugar cane polyphenols. The vinasse can be prepared from a feed stock ultimately sourced from sugar cane such as sugar cane juice, sugar cane molasses, massecuite, or raw or brown sugar cane sugar. Sugar cane juice or molasses are preferred.

The term “sugar juice” refers to the syrup or liquid produced from sugar-rich plant feedstocks, such as the juice produced following crushing/pressing sugar cane or the liquid exiting a diffuser during the processing of sugar beets.

The term “cane juice” or “sugar cane juice” refers to the syrup produced from pressed and/or crushed peeled sugar cane. Ideally sugar cane juice is at least 60° Brix.

The term “beet juice” refers to the liquid exiting a diffuser after the beet roots have been sliced into thin strips called cossetes and passed into a diffuser to extract the sugar content into a water solution.

The term “very low glycaemic” refers to a food with a glucose-based GI of less than half the upper limit of low GI (ie the GI is in the bottom half of the low GI range).

Vinasse or Dunder

Vinasse and dunder are both terms for an effluent byproduct of the sugar and ethanol industries. It is produced when carbohydrate is fermented to produce alcohol (during, for example bioethanol production or the production of rum) or amino/organic acid (eg ascorbic acid) or to propagate yeast. Specifically, it is a byproduct of the distillation step subsequent to fermentation of carbohydrates obtained from different sources of saccharides materials (eg sugarcane, sugar beet, starchy materials and lignocellulose materials). For example, vinasse is the liquid left in the boiler after distilling a batch of rum. Vinasse contains high organic matter concentrations. For the purposes of this invention the carbohydrate source includes polyphenols such as sugar cane juice or sugar cane molasses. As bioethanol production increases, the amounts of vinasse increase and alternate methods to dispose of the vinasse are in need.

Vinasse is the remaining biomass and yeasts after distillation of bioethanol produced through fermentation. Commercial fermentation is performed on a carbohydrate-rich feedstock where the carbohydrate is easily accessible. Fermentation is a process that typically begins aerobically but becomes anaerobic, leading to production of ethanol. This production of ethanol selects microorganisms (mainly yeasts) that are able to grow in an alcoholic environment. Most yeasts can only tolerate a maximum alcohol percentage of 10-15%. Accordingly, the yeast cells die before the population can move on to fully digest the food sources in the mixture that are less readily accessible than easily accessible carbohydrates.

Vinasse can be obtained from sugar and bioethanol producers.

Fermentation of Molasses

Molasses is optionally transferred from storage tanks to a fermentation tank where it is tested for pH, bacterial, and essential mineral levels. Sulfuric acid is used to adjust and maintain the pH level during fermentation. Water and yeast are added to the molasses mixture to start fermentation. The molasses mixture is allowed to ferment (eg for 12-40 hours) for (i) ethanol propagation for rum and industrial grade alcohol, biofuel; (ii) yeast propagation; and (iii) amino/organic acid production. Ammonium compounds or yeast extracts may also be used to raise the nitrogen level of the solution to required levels necessary for fermentation.

A similar process can be used to ferment sugar cane juice.

Alcohol Distillation After fermentation, the yeast, which has settled to the bottom of the tank, is separated from the liquor mixture. The separated liquor mixture is fraction distilled.

Batch distillation may be performed with various types of well-known equipment.

The simplest form is a single simple pot still. The fermented product (often referred to as beer) is heated in a pot fitted with a vapor pipe, which leads to a condenser coil immersed in a water tank. As the beer is heated, the alcohol and other volatile congeners are distilled off, condensed, and run into a storage tank. The process is continued until most of the alcohol has been distilled out.

The residue, or stillage, is emptied out of the pot and the distillate is optionally returned from the storage tank to the pot to be redistilled to increase the proof. The stillage is also known as vinasse or dunder. This vinasse can be included in sugars of the invention. The vinasse can also be further processed to vinasse digestate and/or to reduce its odour to prepare a polyphenol composition of the invention.

Fermentation and distillation of sugar cane can generate ten times the volume of vinasse to the ethanol produced.

Yeast Propagation

Yeast propagation can also follow the fermentation process.

Yeast cells are grown in a series of fermentation vessels. Yeast fermentation vessels are operated under aerobic conditions. Once the optimum quantity of yeast has been grown, the yeast cells are recovered at the final fermentation stage by centrifugal yeast separators. Vinasse is the remains of the feedstock after the final fermentation stage.

Vinasse can then be used as feedstock in biofuel production, as an agricultural fertilizer and soil conditioner, to prepare polyphenol containing sugars, or further processed to vinasse digestate and/or to reduce its odour.

Vinasse Composition

Vinasse is mainly of plant origin, with some microbial residue (yeast). It components vary based on the starting material used. The components of vinasse are readily metabolized and utilized by microorganisms as energy sources. Vinasse is a dark brown liquid that can have a a boiling point of over 100° C., a relative density at 20° C. (kg/I) of about 1.33, a viscosity of about 100 cps at 20° C. and forms an infinite aqueous solution is water.

The vinasse from sugar cane juice is acidic (reported as pH 3.5-5.4 but also as 5.4 to 6.8), predominantly soluble (eg about 80% soluble or more) and has an organic matter concentration (Chemical Oxygen Demand (COD) of 50-150 g O₂/L). The biochemical oxygen demand (BOD) can be about 75% of the COD. COD/BOD ratios can be about 1.3 indicating high biodegradability. This makes vinasse suitable for anaerobic digestion. Vinasse can have 1230±630 mg/L of nitrogen, 190±35 mg/L phosphorus, 3500±2500 mg/L sulfate (See Naspolini 2017). Vinasse also contains the macronutrients required for microorganisms in anaerobic digestion. Vinasse can be processed to prepare digestate.

The vinasse assessed in Ahmed 2013 at 28.33° C. was 11.02° Brix, 22.9 μs/com conductivity, pH 4.31 10500 mg/I dissolved solids, 4633 mg/I suspended solids and contained 1735 mg/I calcium, 86 mg/I copper, 17 mg/I Iron (Fe), 14 mg/I manganese, 0.01 mg/I aluminium, 820 mg/I sulphate (SO₄), 78 mg/I phosphate (PO₄), and 600 mg/I nitrate (NO₂) but was devoid of all microbial groups, which is expected following the distillation processing temperatures. Molasses vinasse had a COD 48 g O₂/L and BOD 25.8 g O₂/L. The COD/BOD ratio was then 1.86 with lower biodegradability than the Naspolini 2017 sugarcane juice vinasse. The vinasse was about 82% moisture, about 10% ash, about 6% protein and under 1% carbohydrates. In Brazil vinasse from sugar cane juice and molasses has been reported as having about 15% and about 20% ash respectively indicating that content can vary based on the region from which the sugarcane juice, molasses or other carbohydrate used to produce ethanol is sourced.

According to Devia-Orjuela (2019), vinasse is characterized by low pH values, high chemical oxygen demand (COD: 32,000-109,700 mg/L), and biological oxygen demand (BOD: 13,414-87,700 mg/L). Vinasse is composed mainly of water; organic solids; and minerals like potassium, calcium, and magnesium. Powdered vinasse was found to have 23% lingnin, 12.7% cellulose and 8.7% hem icellulose.

Vinasse includes some sugars (for example, fructose, and/or galactose) and sugar alcohols (for example, mannitol, xylitol, and/or dulcitol). Sugar alcohols are produced as byproducts of the ethanol-producing yeasts used to generate the ethanol and vinasse. Vinasse can be, for example, 8-12 or 10° Brix. This makes vinasse suitable for further anaerobic digestion.

Commercially Available Vinasse/Dunder

BioDunder® is a liquid by-product of ethanol that is produced using the Biostil fermentation/distillation process at Wilmar BioEthanol's Sarina Distillery, Queensland, Australia. BioDunder, (which contains approximately 30-40% solids) is the end product of molasses fermentation (following distillative removal of alcohol) and comprises vegetable matter (yeast biomass) containing potassium, sodium, nitrogen, calcium, magnesium, phosphorous and sulphur. Biodunder® is a dark, brown/black viscous liquid generally containing 5-35% protein, 11-65% ash, 5-25% carbohydrates, 1-6% glycerol, and 30-80% water by weight. It generally has a pH of 4.0-4.5 and a specific gravity of about 1.12 at 20° C. The glycerol is added to the raw dunder to prepare the commercial product. For the purposes of this invention, it is preferable to source the dunder prior to addition of the glycerol and/or remove the glycerol prior to use of the dunder in the methods of the invention or to prepare the vinasse/digestate of the invention.

Digestate

Digestate is the liquid remnants of the original input (ie feedstock) material following microbial digestion including, in particular, anaerobic digestion. Polyphenols remain in the digestate.

Any product of anaerobic digestion of biodegradable feed stocks (including vinasse) could be considered a digestate. However, in industry, digestate often, in context, refers to the product of an anaerobic digestion of feed stocks lacking high levels of easily accessible carbohydrate. The digestate remaining following digestion of a low accessible carbohydrate feedstock (such as vinasse) is different to vinasse. Digestion in low carbohydrate/low alcohol conditions leads to different volatile products being produced through anaerobic digestion, mainly biogas. As opposed to the formation of alcohol during fermentation of compositions high in easily digestible carbohydrates (such as sugar cane juice).

Digestate pH varied between 6.5 to 9.5 whereas vinasse pH may be as low as 3.5 due to higher content of residual organic and volatile acetic acids from fermentation including acetic, fulvic and aconitic acids which form very stable mineral chelates of boron, calcium, copper, iron, manganese, zinc.

Anaerobic Digestion

Anaerobic digestion is widely used as a source of renewable energy. The process produces a biogas, consisting of methane, carbon dioxide, and traces of other ‘contaminant’ gases. This biogas can be used directly as fuel, in combined heat and power gas engines or upgraded to natural gas-quality biomethane. Anaerobic digestion also produces a nutrient-rich digestate byproduct that can be used as fertilizer. Anaerobic digestion is used as part of the process for treating biodegradable waste. Anaerobic digesters can also be fed with purpose-grown energy crops, such as sugar cane.

Anaerobic digestion is a staged process. The stages are as follows:
Hydrolysis: breakdown of complex insoluble organic matter into simple sugars, fatty acids, and amino acid.
Acidogenesis: further breakdown of simple sugars, fatty acids, and amino acids into alcohols & volatile fatty acids (VFAs).
Acetogenesis: conversion of VFAs and alcohols into acetic acid, CO₂, and hydrogen.
Methanogenesis: acetic acid and hydrogen are converted into methane and CO₂ by methanogenic bacteria.

There are mesophilic, acidophilic and thermophilic anaerobic digestion systems.

The digestion process begins with bacterial hydrolysis of the input materials (for example vinasse) in order to break down insoluble organic polymers such as carbohydrates (eg lignin, cellulose and hem icellulose) and make them available for other bacteria. Acidogenic bacteria then convert the sugars and amino acids into carbon dioxide, hydrogen, ammonia, and organic acids. Acetogenic bacteria then convert these resulting organic acids into acetic acid, along with additional ammonia, hydrogen, and carbon dioxide. Finally, methanogens convert these products to methane and carbon dioxide.

Various versions of anaerobic digestion are in commercial use and are considered suitable to prepare digestates of the invention.

Batch or Continuous

Anaerobic digestion can be performed as a batch process or a continuous process. In a batch system, biomass is added to the reactor at the start of the process. The reactor is then sealed for the duration of the process. In its simplest form batch processing needs inoculation with already processed material to start the anaerobic digestion.

In continuous digestion processes, organic matter is constantly added (continuous complete mixed) or added in stages to the reactor (continuous plug flow; first in—first out). Here, the end products are constantly or periodically removed, resulting in constant production of biogas. A single or multiple digesters in sequence may be used. Examples of this form of anaerobic digestion include continuous stirred-tank reactors, upflow anaerobic sludge blankets, expanded granular sludge beds, and internal circulation reactors.

In preferred embodiments, a continuous digestion process is used to prepare digestates of the invention.

Vinasse Digestate

Vinasse digestate is the non-volatile materials that remain after fermentation and distillation to produce vinasse and then further anaerobic digestion. Optionally, the further anaerobic digestion is after the initial volatiles have been removed. This process involves anaerobic digestion in an environment with substantial alcohol and then anaerobic digestion in a substantially-alcohol free or low alcohol environment.

In preferred embodiments, the polyphenol composition of the invention is sugar cane vinasse digestate. Either sugar cane juice or molasses is fermented and then distilled to produce ethanol. The vinasse by-product of this process is then fed into an anaerobic digestor to produce biogas. Optionally, this is a continuous digestor that only requires inoculation at the beginning of ethanol production season.

The anaerobic digestor converts vinasse into biogas (gas), digestate (liquid) and sludge (solid). Some sugar cane mills that produce ethanol also have a digestor onsite that is essentially a covered lagoon. Biogas is captured under the covers and continuously vented from the digestor, dried and compressed to use as a fuel source. Digestate overflows into a digestate well and is pumped out to a storage facility. Sludge builds up in the digestor and is removed as needed. This can be as infrequently as once at the end of the season.

Digestors of 140,000 m³ can be used at a consistent incoming flowrate of 100 kL/day per digestor. No water is added, however the incoming total solids from vinasse production can vary. Temperature is ambient, which during the 4-5 month long season is 25-35° C. Residence time in the lagoon is approximately 100 days.

Drying and Reconstituting

If needed, the vinasse and/or digestate is optionally concentrated to 30-50° Brix (eg about 40° Brix).

The vinasse and digestate can both be spray dried, for example, for easy transport. The powdered form is relatively stable and easier to transport. Dried vinasse and/or digestate can be combined with a sugar to increase polyphenol content. Alternatively, the vinasse and/or digestate powder concentrate can be reconstituted into liquid form with either water or affination syrup (for example, in a 1:10 ratio or to about 10° Brix) and then combined with the sugar.

Polyphenol Content Measurement

Polyphenol content can be measured in terms of its catechin equivalents or in terms of its gallic acid equivalents (GAE). Amounts in mg CE polyphenols/100 g can be converted to mg GAE polyphenols/100 g by multiplying by 0.81 ie 60 mg CE polyphenols/100 g is 49 mg GAE polyphenols/100 g.

A laboratory method for determining polyphenol content is described in Kim, Dae-Ok (2003).

Odour Measurement

There are various methods for measuring odour. These methods are both sensory and instrumental. The testing used in this specification has been informal sensory testing and is explained in the examples, definitions and throughout the specification as appropriate. More formal testing can be conducted by dynamic olfactometry.

Dynamic olfactometry is a sensorial method standardized by the European Standard EN13725:2003 (Standard EN 13725:2003. Air Quality-Determination of Odour Concentration by Dynamic Olfactometry; CEN:Brussels, Belgium, 2003), which provides the odour concentration of a sample, referring to the sensation that it causes in a panel of opportunely selected people directly exposed to that odour.

The odour concentration, expressed in European odour units per cubic meter (ouE/m³), represents the number of dilutions with neutral air that are necessary to bring the concentration of the sample to its odour detection threshold (OT), i.e., the threshold at which the odour is perceived by 50% of the examiners. To put it in the simplest manner, if the sample needs to be diluted 100 times with clean air so that the panel cannot perceive the odor anymore, this means that the sample has a concentration of 100 ouE/m³.

The analysis is carried out by presenting the sample to the examiners (i.e., panelists) at increasing concentrations by means of a dilution device, called an olfactometer, which dilutes the samples according to given ratios with reference air, which is made odour- and humidity-free through filtration with active carbon or silica gel.

In order to ensure reliable and repeatable results, the EN 13725:2003 fixes precise criteria for panel selection based on individuals' threshold for n-butanol in nitrogen (between 20 and 80 ppb) and the standard deviation of the individual's responses, which are verified periodically.

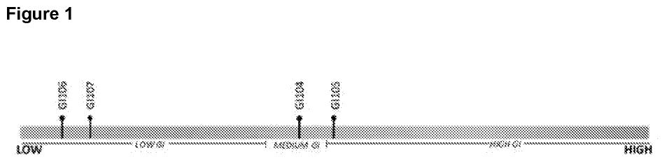

German guidelines VDI 3882 Part 1 (Blatt 1: 1992, Olfactometry; determination of odour intensity) and VDI 3882 Part 2 (1994, Olfactometry—determination of hedonic odour tone), describe how to apply olfactometric measurements for the determination of odour intensity and odour pleasantness/unpleasantness (hedonic tone). Odour intensity is expressed in a scale from 0 (not perceptible) to 6 (extremely strong). Hedonic tone is measured in a scale from −4 (extremely unpleasant) to +4 (extremely pleasant) (FIG. 1).

The odour intensity scale is not perceptible (0), very weak (1), weak (2), distinct (3), strong (4), very strong (5), or extremely strong (6). The sugar cane vinasse or sugar cane digestate starting material can be distinct, strong, very strong or extremely strong in odour (ie a 3-6). The reduced odour polyphenol compositions of the invention are not perceptible, very weak, weak, or distinct in odour (ie a 0-3) in the odour intensity scale. The original digestate, vinasse or vinasse digitate is strong, very strong, or extremely strong in odour (ie 4-6).

Glycaemic Response (GR)

GR refers to the changes in blood glucose after consuming a carbohydrate-containing food. Both the GI of a food and the glycaemic load (GL) of an amount of a food are indicative of the glycaemic response expected when food is consumed.

GI

The glycaemic index is a system for classifying carbohydrate-containing foods according to the relative change in blood glucose level in a person over two hours after consuming that a food with a certain amount of available carbohydrate (usually 50 g). The area under the two hour blood glucose response curve (AUC) is divided by the AUC of a glucose standard, where both the standard and the test food must contain an equal amount of available carbohydrate. An average GI is usually calculated from data collected from 10 subjects. Prior to a test the person would typically have undergone a twelve hour fast. The glycaemic index provides a measure of how fast a food raises blood-glucose levels inside the body. Each carbohydrate containing food has a GI. The amount of food consumed is not relevant to the GI. A higher GI means a food increases blood-glucose levels faster. The GI scale is from 1 to 100. The most commonly used version of the scale is based on glucose. 100 on the glucose GI scale is the increase in blood-glucose levels caused by consuming 50 grams of glucose. High GI products have a GI of 70 or more. Medium GI products have a GI of 55 to 69. Low GI products have a GI of 54 or less. These are foods that cause slow rises in blood-sugar.

Those skilled in the art understand how to conduct GI testing, for example, using internationally recognised GI methodology (see the Joint FAO/WHO Report), which has been validated by results obtained from small experimental studies and large multi-centre research trials (see Wolever et al 2003).

In vitro GI testing is now also available, see Example 6.

GL

Glycaemic load is an estimate of how much an amount of a food will raise a person's blood glucose level after consumption. Whereas glycaemic index is defined for each type of food, glycaemic load is calculated for an amount of a food. Glycaemic load estimates the impact of carbohydrate consumption by accounting for the glycaemic index (estimate of speed of effect on blood glucose) and the amount of carbohydrate that is consumed. High GI foods can be low GL. For instance, watermelon has a high GI, but a typical serving of watermelon does not contain much carbohydrate, so the glycaemic load of eating it is low.

One unit of glycaemic load approximates the effect of consuming one gram of glucose. The GL is calculated by multiplying the grams of available carbohydrate in the food by the food's GI and then dividing by 100. For one serving of a food, a GL greater than 20 is high, a GL of 11-19 is medium, and a GL of 10 or less is low.

Cane Juice

Cane juice contains all the naturally occurring macronutrients, micronutrients and phytochemicals present in the syrup extracted from pressed and/or crushed peeled sugar cane that are normally removed in white refined sugar, which is 99.9% sucrose.

Molasses

Is a viscous by-product of sugar preparation, which is separated from the crystallised sugar. The molasses may be separated from the sugar at several stages of sugar processing. Molasses contains the same compounds as cane juice but is a more highly concentrated source of phytochemicals.

Spray Drying and Other Drying Methods

Spray drying operates on the principle of convection to remove the moisture from the liquid feed, by intimately contacting the product to be dried with a stream of hot air. The spray drying process can be broken down into three key stages: atomisation of feedstock, mixing of spray and air (including evaporation process) and the separation of dried product from the air. Other appropriate drying methods include fluidized bed drying, ring drying, freeze drying and low temperature vacuum dehydration.

Atomisation

In order to ensure that the particles to be dried have the maximum surface area available to contact the hot air stream, the liquid feed is often atomised, producing very fine droplets ultimately leading to more effective drying. There are several atomiser configurations that exist, the most common being the wheel-type, pneumatic and nozzle atomisers.

Evaporation and Separation

The second stage of the spray drying process involves the evaporation of moisture by using hot gases which flow around the surface of the particles/droplets to be dried.

There are notably three different types of air-droplet contacting configurations that exist: co-current, counter-current and mixed flow, all of which have differing applications depending on the product to be dried.

Both co-current and counter-current drying chambers are able to be used for heat sensitive materials, however the use of mixed-flow drying chambers is restricted to drying materials that are not susceptible to quality degradation due to high temperatures.

The final stage of the spray drying process is the separation of the powder from the air stream. The dry powder collects at the base of the drying chamber before it is discharged or manually collected.

Glass Transition Temperature

The glass transition temperature (Tg) is the substance-specific temperature range at which a reversible change occurs in amorphous materials from the solid, glassy state to the supercooled liquid state or the reverse. The glass transition temperature becomes very important for the production of dried products, particularly in relation to the processing and storage stages of manufacture. The glass transition temperature of the powders can be determined via differential scanning calorimetry (DSC).

ICUMSA

ICUMSA is a sugar colour grading system. Lower ICUMSA values represent less colour. ICUMSA is measured at 420 nm by a spectrophotometric instrument such as a Metrohm NIRS XDS spectrometer with a ProFoss analysis system. Currently, sugars considered suitable for human consumption, including refined granulated sugar, crystal sugar, and consumable raw sugar (ie brown sugar), have ICUMSA scores of 45-800. Sugars with scores above 800 are currently used for cosmetics or other non-edible purposes, but require further processing to be fit for human consumption. Consequently, the food grade sugars of the invention with ICUMSA values of 500 to 5000 ICUMSA are unexpected.

The sugar particles of the present invention may optionally be prepared using the methods and systems described in Australian Provisional Patent Application No 2016902957 filed on 27 Jul. 2016 with the title “Process for sugar production” or International Patent Publication number WO 2018/018089 with the same title.

Arsenic Reduction

If the arsenic levels of the vinasse or digestate are too high, they can be reduced by known methods including use of calcium-alginate beads (see Bezbaruah 2014).

### Preparation of a Sugar Using the Polyphenol Composition of the Invention

Beet sugar does not contain polyphenols and neither does refined white sugar contain more than trace amounts of polyphenols. Polyphenols can be added to either to lower the glycaemic index of the sugar and prepare, for example, a low glycaemic or very low glycaemic sugar. Sugars prepared by controlled washing of sugar cane massecuite, for example, using the controlled washing method as described in patent publication numbers WO 2018/018090 and/or WO 2018/018089 to produce a sugar of 20 to 45 mg CE polyphenols/100 g carbohydrate and suitable reducing sugar content, further polyphenols can be added by combining that sugar with vinasse, digestate or a polyphenol composition of the invention to the sugar.

The further polyphenols may be added to the sugar in a powdered or liquid form. One option is to spray the liquid or powdered polyphenols onto the sugar. The process for adding the polyphenol additive onto the sugar can be completed as described in international patent application number PCT/SG2019/050377.

It is preferred that the polyphenols added to the sugar are polyphenols that, even if not sourced from sugar cane, are present in sugar cane. The polyphenols can be sourced from sugar cane, for example, from sugar cane vinasse (for example following distillation of sugar cane juice or molasses) or sugar cane digestate (following anaerobic digestion of sugar cane, sugar cane juice, molasses or sugar cane vinasse) or sugar cane vinasse/digestate diluted with or dissolved in water, affination syrup or molasses. Optionally, two or more polyphenol sources are added to the sugar. Preferably, at least one polyphenol source is a polyphenol composition according to the first or second aspects or the invention, their options, embodiments or alternatives. A further polyphenol source is optionally a sugar cane waste stream such as dunder or molasses.

The polyphenol content is then determined and, if needed, additional polyphenols added to achieve the desired amounts such as about 46 mg CE polyphenols/100 g carbohydrate to about 100 mg CE polyphenols/100 g carbohydrate or about 10 mg CE polyphenols/100 g carbohydrate to about 100 mg CE polyphenols/100 g carbohydrate.

### REFERENCES

Ahmed, 0 et al, Physiochemical, Chemical and Microbiological Characteristics of Vinasse, a by-product from ethanol industry, American Journal of Biochemistry (2013) 3(3):80-83.
Australian provisional patent application number 2016902957.
Bezbaruah, A. N. et al, Ca-alginate-entrapped nanoscale iron: arsenic treatability and mechanism studies, Journal of Nanoparticle Research (2014) 16:2175.
Devia-Orjuela, J. S. et al, Evaluation of press mud, vinasse powder and extraction sludge with ethanol in a pyrolysis process, Energies (2019) 12:4145.
International patent publication numbers WO 2018/018090 and WO 2018/018089.
International patent application numbers PCT/SG2019/050377, PCT/SG2019/050416 and PCT/SG2019/050057.
Joint FAO/WHO Report. Carbohydrates in Human Nutrition. FAO Food and Nutrition. Paper 66. Rome: FAO, 1998.
Kim, Dae-Ok, et al, Antioxidant capacity of phenolic phytochemicals from various cultivars of plums, Food Chemistry (2003) 81, 321-26.
Naspolini, B. F. et al, Bioconversion of sugarcane vinasse into high-added value products and energy, BioMed Research International (2017) article ID 8986165.
Singapore patent application number 10201902102Q.
Wolever TMS et al. Determination of the glycemic index values of foods: an interlaboratory study, European Journal of Clinical Nutrition (2003) 57:475-482.

A copy of each of these is incorporated into this specification by reference.

### EXAMPLES

### Example 1—Properties of Liquid Dunder & Digestate Compositions

Liquid sugar cane juice vinasse digestate commercially sourced from a bioethanol manufacturer in Thailand was analysed for phenolic content by both CE and GAE methods. The results were 1.000% w/w as catechin equivalents (1000 mg CE/100 g) or 0.810% w/w as gallic acid equivalents (809.8 mg GAE/100 g).

Several samples of brown to dark brown liquid digestate from different batches were obtained. The digestate used had 9-11% solids as determined by a Brix Meter. The digestate also had 0.94 mg/kg arsenic, less than 0.30 mg/kg antimony; less than 0.03 mg/kg cadmium, 1.9 mg/kg selenium; less than 0.004 mg/kg mercury; and 0.12 mg/kg lead. The digestate has a six month to one year shelf life depending on storage conditions.

### Example 2— Spray Drying Liquid Digestate or Dunder

Sugar cane juice vinasse digestate was commercially sourced from a bioethanol manufacturer in Thailand in liquid form and spray dried to powder form (inlet temperature 160° C. & outlet temperature 80° C.).

The spray drying can be either before or after further processing with activated carbon as described in Example 3 below.

The spray dried digestate was pH tested. The results for two samples was pH 9.2 & 9.5 when 1 g of powder was dissolved in 10 ml water.

The properties of the vinasse digestate powders D1 to D3 are in Table 1. The three digestate samples were assessed for sucrose sugar content by polarisation using HPLC and near infra-red (NIR pol), for conductivity using a conductivity meter, for ash levels using NIR (NIR ash), for colour levels using NIR (NIR colour), for polyphenol levels using a Folin-Ciocalteu laboratory method with UV detection at 760 nm (adapting method from Kim et al for determining mg GAE polyphenols/100 g carbohydrates (Lab GAE). The NIR results were all determined using standard titration methods to correlate NIR reading with ash, colour, polyphenol and other results.

TABLE 1
Properties of a number of digestate powders

| | | Conduct- | NIR | NIR | Lab GAE |
|---|---|---|---|---|---|
| | NIR Pol | ivity | Ash | Color | mg GAE/ |
| Sample ID | % w/w | μs/cm | % w/w | ICUMSA | 100 g |
| Digestate | BDL | 21.9 | 11 | 11106 | 6818 |
| composition | | | | | |
| 1 (D1) | | | | | |
| Digestate | <1 | 23.2 | 13 | 7805 | 10789 |
| composition | | | | | |
| 2 (D2) | | | | | |
| Digestate | BDL | 24.3 | 11 | 7981 | 11273 |
| composition | | | | | |
| 3 (D3) | | | | | |

The spray dried digestate of the invention is preferably soluble in water. Where the dunder or digestate used to prepare the spray dried powder has an insoluble fraction, the insoluble fraction is preferably removed before spray drying.

Spray dried sugar cane juice vinasse digestate powder was provided to the National Measurement Institute in Australia for analysis. The powder had a standard plate count of 12,000 CFU per g, less than 10 yeast CFU per g, less than 40 mould CFU per g and 1,500 aerobic thermophilic bacterial spores CFU per g.

Based on the results to date, the product specifications for spray dried digestate of the invention are proposed to be as set out in Table 2 below.

TABLE 2
Polyphenol composition specifications

| Chemical Name | Proportion |
|---|---|
| Plant Fibre | <40% w/v |
| Ash | <35% w/v |
| Polyphenols | >7% w/v |
| Parameter | Specification |
| Appearance | Fine Powder |
| Moisture | ≤5.0% |
| pH 10% w/v | 9-9.5 |
| Polyphenols | >7000 mg/100 g GAE |
| Heavy Metals | <2 mg/kg |
| Microbiological Properties | |
| Total Plate Count | ≤15,000 CFU/g |
| Yeast and Mould | ≤1,500 CFU/g |
| Salmonella | Absent |

The spray dried powder generally has less than 2% w/w moisture.

The brown to dark brown fine powder has 2.0 mg/kg arsenic, cadmium and selenium; 1.0 mg/kg mercury; and 0.2 mg/kg lead. The powder is 6.0% and has a bulk density of 0.7-0.85 kg/L. The powder has the following microbiological properties: total plate count of 15,000 CFU/g, yeast of 500 CFU/g and no salmonella.

Following the above invention, spray drying was also conducted with sugar cane digestate concentrated to 25 brix. The concentrate is passed through an evaporator at 80° C. for 1 minute and then pumped into the spray dryer. This process produces acceptable dry powder.

### Example 3— Further Processing Digestate by Activated Carbon to Reduce Odour

The effect on odour and GAE levels for polyphenols upon contact of digestate with powdered activated carbon (PAC) was studied.

The loose PAC was pre-washed prior to the tests. 400 g of PAC was pre-washed with 1 L of distilled water to remove carbon dust. The water was decanted and discarded and replaced with fresh distilled water at regular intervals over a 48 hour period until the water was no longer coloured. At this point, the water was discarded and carbon was dried in an oven at 100° C. until the carbon was desiccated to powder form.

Spray dried digestate powder (20 g) was mixed with distilled water and made up to 100 ml volumetrically. 5×5 ml aliquots of this mixture were taken. 0.4 g of washed PAC was added to four of these aliquots. All five aliquots were made up to 100 ml volumetrically. All five diluted flasks were placed on a mechanical stirrer and agitated for mixing according to an assigned PAC contact time (0, 15, 30, 45, 60 min). The sample with a PAC contact time of 0 min was the sample where PAC was not added.

Upon mixing and after the nominated PAC contact time had elapsed, the samples were filtered through Whatman 41 (0.22 μm) filter paper. Filtered subsamples were analysed for polyphenol content according to Kim et al. Unfiltered samples with a PAC content time of 0 min were also analysed for polyphenol content according to Kim et al. The odour of the filtered subsamples was also assessed by a panel of 4 people.

The results of this testing is tabulated below in Table 3. Odour was found to decrease with increased PAC time. GAE levels did not greatly decrease with increased PAC time.

TABLE 3
PAC contact time vs GAE levels and sensory profile

| | PAC | | | | Sensory |
|---|---|---|---|---|---|
| Sam- | contact | | Dilution | GAE mg/ | Analysis |
| ple | time | Filtered | for assay | 100 g | (4 people) |
| 1 | 0 min | No | 1/100 | 11423 | earthy smell |
| 2 | 0 min | No | 1/200 | 10073 | earthy smell |
| 2 | 0 min | Yes | 1/200 | 10202 | earthy smell |
| 3 | 15 min | Yes | 1/200 | 9329 | moderate |
| | | | | | earthy smell |
| 4 | 30 min | Yes | 1/200 | 10566 | slight earthy |
| | | | | | smell |
| 5 | 45 min | Yes | 1/200 | 10022 | no odour |
| 6 | 60 min | Yes | 1/200 | 9842 | no odour |

Spray dried activated carbon processed digestate stored in clear, sealed, plastic bags has a shelf life of 6 months to 1 year.

### Example 3a-Further Processing of Digestate to Reduce Odour

The effect of activated carbon on odour and turbidity for sugar cane juice vinasse digestate was further studied. The testing was conducted by SLS Global Technical Support of Pall Corporation in Bangkok, Thailand.

Liquid vinasse digestate of 44° and 10° brix was commercially sourced as starting material. These samples had a dark brown colour and strong odour from organic compounds. The 44° brix sample had high viscosity. The 10° brix sample had low viscosity.

Reduction in Turbidity

The 10° brix sample was pre-filtered using Seitz® K900 sheet filter at a flow rate of 15 ml/min (Flux rate 400 LMH) at 25° C. with filtrate volume 700 ml at differential pressure 2.0 bar. Seitz® K900 sheet filters are 4.3 mm thick sheets made of cellulose, diatomaceous earth and perlite. The K900 is 46% ash with water permeability of 1700 L/m²/m in. The turbidity value decreased from 70.5 NTU to 50.6 NTU with no effect on the odour. Odour was inspected manually by the conductor of the test smelling the sample. See Table 3a below.

TABLE 3a
Result of trial with 10° brix sample pre-filtered using
Seitz ® K900 sheet filter at a flow rate of 15 ml/min
(Flux rate 400 LMH) at 25° C.:

| | Differential Pressure | Turbidity Value |
|---|---|---|
| Volume (ml) | (bar) | (NTU) |
| Start | 0 | 70.5 |
| 100 | 0.5 | n/a |
| 200 | 0.9 | n/a |
| 300 | 1.2 | n/a |
| 400 | 1.4 | n/a |
| 500 | 1.5 | n/a |
| 600 | 1.7 | n/a |
| 700 | 2.0 | 50.6 |

Reduction in Odour

The pre-filtered 10° brix vinasse digestate was then filtered using Seitz® Stax depth filters AKS2 or AKS4 at a flow rate of 10 ml/min (Flux rate 272 LMH) at 25° C. with filtrate volume 300 ml at differential pressure 2.0 bar.

The AKS2 targets 400-1000 dalton contaminates and is recommended for use in high efficiency decolourisation having 1.4 kg PAC in the 12 inch module. The AKS4 targets 400-1500 dalton contaminants and is a low efficiency general purpose filter having 0.7 kg PAC in the 12 inch module.

A larger filter is recommended for filtering 700 ml volume or filtering in 600 ml volumes or less at a time.

Odour was inspected manually by the conductor of the test smelling the sample. The results are presented in Tables 3b and 3c below.

TABLE 3b
Result of trial with 10° brix sample filtered using Seitz ®
AKS2 at a flow rate of 15 ml/min (Flux rate 400 LMH)
at 25° C.; following pre-filtration as described above:

| | Differential | Turbidity Value | |
|---|---|---|---|
| Volume (ml) | Pressure (bar) | (NTU) | Odour Test |
| Start | 0 | 50.6 | Strong odour |
| 100 | 0.8 | n/a | Not detected |
| 200 | 1.5 | n/a | Not detected |
| 300 | 2.0 | 41.6 | Not detected |

TABLE 3c
Result of trial with 10° brix sample filtered using Seitz ®
AKS4 at a flow rate of 15 ml/min (Flux rate 400 LMH) at 25°
C.; following pre-filtration as described above:

| | Differential | Turbidity Value | |
|---|---|---|---|
| :Volume (ml) | Pressure (bar) | (NTU) | Odour Test |
| Start | 0 | 50.6 | Strong odour |
| 100 | 0.5 | n/a | Light odour |
| 200 | 1.0 | n/a | Light odour |
| 300 | 2.0 | 40.5 | Light odour |

Filtration of the 10° brix sample using a Seitz® AKS2 filter following pre-filtration resulted in a sample where odour could not be detected. Filtration of the 10° brix sample using a Seitz® AKS2 filter following pre-filtration resulted in a sample where only light odour could be detected. The odour could potentially be further removed by a second filtration step with this filter.

The 44° brix sample blocked the Seitz® AKS2 and AKS4 filters at both 25° C. and 60° C. due to high particle counts and the high viscosity of the sample. Therefore, viscosity reduction, for example by dilution or increase in temperature, is recommended before filtering.

It is expected that increasing the temperature of filtration from 25° C. to a temperature such as to 60° C. will decrease the viscosity of digestate samples, including the 10° brix sample. It is expected that this will increase the lifetime of filters used in connection with the samples.

Similarly, it is expected that the retention of more particles in the pre-filtration stage would also increase the lifetime of the filters used subsequently. This could be achieved by using a finer grade pre-filter, such as a Supradisc™ II X700 depth filter module. This module could be regenerated through operation in the reverse direction.

### Example 3a-Pilot Scale Processing of Digestate to Reduce Odour

Pilot scale carbon filtration was tested as follows.

Pre-filtration using a Supradisc™ II X700 depth filter module was performed at a flux rate of 200 LMH (L/hr/m²) and a flow rate of 110 L/h on:

10° Brix digestate obtained via dilution of a more viscous digestate with water

(Sample A); and 10° Brix digestate obtained by dissolution of an evaporated sample of digestate in water (Sample B).

The pre-filter was cleaned by backwash, ie reverse direction water flow, between each filtration.

The pre-filtered samples were then carbon filtered through a Supradisc™ AKS4 module at a flux rate of 200 LMH (flow rate 110 L/h) to reduce odour. The results for Samples A and B are in Tables 3d and 3e, respectively. It is expected that use of a coarser pre-filter such as a Supradisc™ IIT 1000 would be successful and increase the filtration cycle time before backwash.

TABLE 3d
Result of filtration trials of 10° brix sample obtained via
dilution of liquid concentrate

| | | | | |
|---|---|---|---|---|
| Initial dP | Final dP | Time | Volume | Turbidity |
| (bar) | (bar) | (min) | (L) | (NTU) |

Pre-filtration of Sample A

| | | | | | |
|---|---|---|---|---|---|
| Start | 0.1 | 2.5 | 10 | 20 | 200 |
| 1^{st} fraction | 0.1 | 2.5 | 10 | 20 | 40.6 |
| filtration | | | | | |
| 2^{nd} | 0.1 | 2.5 | 10 | 20 | 41.0 |
| fraction | | | | | |
| filtration | | | | | |
| 3^{rd} | 0.1 | 2.5 | 10 | 20 | 42.2 |
| fraction | | | | | |
| filtration | | | | | |
| 4^{th} | 0.1 | 2.5 | 10 | 20 | 40.5 |
| fraction | | | | | |
| filtration | | | | | |
| 5^{th} fraction | 0.1 | 2.5 | 10 | 20 | 41.3 |
| filtration | | | | | |
| 6^{th} fraction | 0.1 | 2.5 | 10 | 20 | 41.5 |
| filtration | | | | | |
| 7^{th} fraction | 0.1 | 2.5 | 10 | 20 | 40.2 |
| filtration | | | | | |

Carbon filtration of Sample A

| | | | | | |
|---|---|---|---|---|---|
| Filtration | 0.1 | 0.1 | 60 | 160 | 32.7 |

The odour was strong before and after pre-filtration. Following the carbon filtration, the odour was reduced to slight.

TABLE 3e
Results of pre-filtration and filtration of 10° brix sample
dissolved from evaporate

| | | | | |
|---|---|---|---|---|
| Initial dP | Final dP | Time | Volume | Turbidity |
| (bar) | (bar) | (min) | (L) | (NTU) |

Pre-filtration of Sample B

| | | | | | |
|---|---|---|---|---|---|
| Start | 0.1 | 2.5 | 10 | 20 | 220 |
| 1^{st} fraction | 0.1 | 2.5 | 10 | 20 | 40.0 |
| filtration | | | | | |
| 2^{nd} | 0.1 | 2.5 | 10 | 20 | 40.2 |
| fraction | | | | | |
| filtration | | | | | |
| 3^{rd} | 0.1 | 2.5 | 10 | 20 | 41.1 |
| fraction | | | | | |
| filtration | | | | | |
| 4^{th} | 0.1 | 2.5 | 10 | 20 | 40.4 |
| fraction | | | | | |
| filtration | | | | | |

Carbon filtration of Sample B

| | | | | | |
|---|---|---|---|---|---|
| 1^{st} | 0.1 | 0.1 | 60 | 100 | 35.5 |
| Filtration | | | | | |

The sample had a strong odour both before and after pre-filtration. Following filtration only a slight odour remained.

Following the deodorising of the sugar cane digestate, the digestate was concentrated to about 25 brix and spray dried at 200-260° C. The resulting dry powder had the following composition:

| Properties | | Unit of | | | Unit of |
|---|---|---|---|---|---|
| of | | measure- | Properties of | | measure- |
| NIX | Result | ment | NIX | Result | ment |
| Crude | 18.70 | % of dry | Calcium | 27000 | mg/kg |
| protein | | matter | | | (ppm) |
| Crude fibre | 0.10 | % | Phosphorus | 1800 | mg/kg |
| | | | | | (ppm) |
| Crude fat | 0.70 | % | Magnesium | 20000 | mg/kg |
| | | | | | (ppm) |
| Ash | 30.27 | % | Potassium | 100000 | mg/kg |
| | | | | | (ppm) |
| Dry matter | 96.50 | % | Sodium | 3100 | mg/kg |
| | | | | | (ppm) |
| Moisture | 3.50 | % | Sulphur | 8900 | mg/kg |
| | | | | | (ppm) |
| Total sugars | 0.11 | % | Iron | 360 | mg/kg |
| | | | | | (ppm) |
| PH | 9.00 | | Zinc | 45 | mg/kg |
| | | | | | (ppm) |
| Polyphenols | 10 000 | mg/100 g | Selenium | 1.9 | mg/kg |
| | | GAE | | | |
| Total plate | <10 000 | cfu/g | Antimony | ND | mg/kg |
| count | | | | | |
| Yeast | <100 | cfu/g | Arsenic | 0.94 | mg/kg |
| Mould | <100 | cfu/g | Cadmium | <0.03 | mg/kg |
| Salmonella | ND | In 25 g | Lead | 0.12 | mg/kg |
| E.coli | <3 | MPN/g | Mercury | ND | mg/kg |

The powder also has about 1,000 GAE mg/100 g. This is 5 times the polyphenols of molasses (about 200 GAE mg/100 g).

### Example 3b— Polyphenol Levels During Odour Reduction Process

K900 (pre-filter) + AKS2 carbon filter

| | | % reduction in |
|---|---|---|
| sample fraction | GAE mg/100 ml | polyphenols |
| Sample 10 brix | 507.6 | — |
| K900 (pre-filter) | 509.2 | 0 |
| AKS2 0-100 ml | 357.1 | 30 |
| AKS2 100-200 ml | 477.8 | 6 |
| AKS2 200-300 ml | 482.1 | 5 |
| Average | | 13.67 |

The carbon filtration only results in a 5-30% reduction in polyphenols.

K900 (pre-filter) + AKS4 carbon filter

| | | % reduction in |
|---|---|---|
| Sample fraction | GAE mg/100 ml | polyphenols |
| Sample 10 brix | 507.6 | — |
| K900 (pre-filter) | 509.2 | 0 |
| AKS4 0-100 ml | 404.8 | 20 |
| AKS4 100-200 ml | 463.8 | 9 |
| AKS4 200-300 ml | 424.5 | 16 |
| Average | | 15% |

This carbon filtration only resulted in a 9-20% reduction in polyphenols.

Overall odour reduction was achieved with an average of 14.3% loss of polyphenols (ie 5-30% polyphenol reduction).

### Example 4— Further Processing of Digestate

The high boiling point fraction of the digestate may be removed under reduced pressure. Reduced pressure removes and/or decreases the volatile components. For example, the carboxylic acid (such as acetic acid) and aldehyde components in the vinasse are reduced when the high boiling point fractions is removed.

### Example 5— Reconstitution of Polyphenol Composition for Spraying

The spray dried digestate of Example 2 (optionally processed in accordance with Examples 3 and/or 4) can be reconstituted into a liquid—for example after transport to the facility for preparation of a polyphenol enhanced sugar. The polyphenol composition spray dried powder (optionally 10,000 GAE mg/100 g but varies batch to batch) was combined with affination rehydration syrup of 40° Brix.

The rehydration syrup has no polyphenols. The syrup and powder were combined at a 10 g/g ratio and sprayed as a liquid onto a base sugar (optionally GAE mg/100 g but varies batch to batch).

The skilled person is able to calculate the amount of liquid composition to spray onto the base sugar to achieve a desired polyphenol composition in a final sugar.

The reconstituted polyphenol composition liquid generally contains:

| Chemical Name | Proportion | |
|---|---|---|
| Protein | <3% | w/v |
| Ash | <5% | w/v |
| Carbohydrates | <3% | w/v |
| Water | 80-90% | w/v |

### Example 5a— Preparation of Spray Dried Reduced Odour Filtrate

Protocol 1

120-150 L raw sugar cane vinasse digestate of 5-8 brix is pre-filtered and then filtered as described in Example 3a. The digestate is evaporated to about 40 brix and then spray dried to powder form.

Protocol 2

Raw sugar cane vinasse digestate of 5-8 brix is evaporated to about 40 brix. This concentrate is diluted back to 10 brix and about 120 L, pre-filtered and then filtered as described in Example 3a. The 100-120 L of filtered digestate is then spray dried to powder form.

### Example 6— Effect of Polyphenols on GI of Sugar

The effect of polyphenol content on the GI of sugar was studied. Traditional white sugar (ie essentially sucrose) was used as a control. Sugars with varied quantities of polyphenols were prepared by adding various amounts of polyphenol content to traditional white sugar.

Table 4 shows the results of testing of an in vitro Glycemic Index Speed Test (GIST) on the sugars prepared. The method involved in vitro digestion and analysis using Bruker BBFO 400 MHz NMR Spectroscopy. The testing was conducted by the Singapore Polytechnic Food Innovation & Resource Centre, who have demonstrated a strong correlation between the results of their in vitro method and traditional in vivo GI testing.

TABLE 4
Sugar polyphenol content v GI

| Sample | Polyphenol content | GI number | GI |
|---|---|---|---|
| 1 | 0 mg CE polyphenols/ | About 68 | Medium |
| | 100 g carbohydrate | | |
| 2 | 30 mg CE polyphenols/ | <55 (about 53) | Low |
| | 100 g carbohydrate | | |
| 3 | 60 mg CE | <20 (about 15) | Very Low |
| | polyphenols/100 g | | |
| | carbohydrate | | |

While the GI of fructose is 19, the GI of glucose is 100 out of 100. We therefore expect that the as glucose increases in less refined sugars the glycemic response also concurrently increases.

A second set of sugars were prepared in which reducing sugars (1:1 glucose to fructose) were added to some of the white refined sugar plus polyphenol sugars. The GI of these sugars was also tested using the GIST method and the results are in Table 5.

TABLE 5
Effect of polyphenol and reducing sugar content on GI

| Sample # | Name of Material/Sample | Sample Code | GI Banding |
|---|---|---|---|
| 1 | Sugar + 30 mg CE PP/100 g | GI103 | Low |
| | carbohydrate + <0.16% RS | | |
| 2 | Sugar + 30 mg CE PP/100 g | GI104 | Medium |
| | carbohydrate + 0.3% RS | | |
| 3 | Sugar + 30 mg CE PP/100 g | GI105 | Medium/High |
| | carbohydrate + 0.6% RS | | (about 70) |
| 4 | Sugar + 60 mg CE PP/100 g | GI106 | Very low |
| | carbohydrate + 0% RS | | (about 15) |
| 5 | Sugar + 60 mg CE PP/100 g | GI107 | Low (about 29) |
| | carbohydrate + 0.6% RS | | |

*PP = polyphenols;
RS = reducing sugars (1:1 glucose:fructose)

The GI of several samples from Table 3 are graphed in FIG. 3.

### Example 7— Analysis of Polyphenol Content in Sugar

40 g of sugar sample was accurately weighed into a 100 ml volumetric flask. Approximately 40 ml of distilled water was added and the flask agitated until the sugar was fully dissolved after which the solution was made up to final volume with distilled water. The polyphenol analysis was based on the Folin-Ciocalteu method (Singleton 1965) and was adapted from the work of Kim et al (2003). In brief, a 50 μL aliquot of appropriately diluted raw sugar solution was added to a test tube followed by 650 μL pf distilled water. A 50 μL aliquot of Folin-Ciocalteu reagent was added to the mixture and shaken. After 5 minutes, 500 μL of 7% Na₂CO₃ solution was added with mixing. The absorbance at 750 nm was recorded after 90 minutes at room temperature. A standard curve was constructed using standard solutions of catechin (0-250 mg/L). Sample results were expressed as milligrams of catechin equivalent (CE) per 100 g raw sugar. The absorbance of each sample sugar was determined and the quantity of polyphenols in that sugar determined from the standard curve.

Where the sugar is a less refined sugar prepared by a limited wash, an alternative method for analysis of the polyphenol content is to measure the amount of tricin in a sample using near-infra red spectroscopy (NIR). In these circumstances, the amount of tricin is proportional to the total polyphenols. Further information on this method is available in Australian Provisional Patent Application No 2016902957 filed on 27 Jul. 2016 with the title “Process for sugar production” or international patent publication number WO 2018/018089.

### Example 8— Analysis of the Reducing Sugar Content in Sugar

There are several qualitative tests that can be used to determine reducing sugar content in a sugar product. Copper (II) ions in either aqueous sodium citrate or in aqueous sodium tartrate can be reacted with the sugar. The reducing sugars convert the copper(II) to copper(I), which forms a copper(I) oxide precipitate that can be quantified.

An alternative is to react 3,5-dinitrosalicylic acid with the sugar. The reducing sugars will react with this reagent to form 3-amino-5-nitrosalicylic acid. The quantity of 3-amino-5-nitrosalicylic acid can be measured with spectrophotometry and the results used to quantify the amount of reducing sugar present in the sugar product.

### Example 9—Preparation of a Sugar Using a Digestate of the Invention for Polyphenol Content

As discussed above, polyphenol levels in dunder and digestate can vary based upon the source employed. Accordingly, in order to produce a sugar comprising a defined level of polyphenol it is necessary to control the amount of digestate (or PAC treated digestate) added based upon the source employed.

The amount of digestate required to produce sugars with polyphenol levels of 60 mg GAE/100 g of material were calculated for digestate concentrates (ie digestate filtered and condensed to a desired concentration) featuring 1000 mg GAE/100 g of material. The washed-sugar to which the PAC treated digestate was applied featured 5 mg GAE polyphenols/100 g carbohydrates. The calculated quantities are tabulated below.

Methods of preparing polyphenol containing sugars are described in PCT/SG2019/050377. The polyphenol compositions of the invention including sugarcane vinasse, sugarcane vinasse digestate and PAC treated sugarcane vinasse digestate polyphenol compositions are suitable for addition to refined white sugar or various incompletely refined sucrose sugars to prepare a sugar as described in that application.

TABLE 6
Levels of digestate required to produce sugars of defined polyphenol levels

| | | |
|---|---|---|
| Polyphenol level in | 1000 mg GAE/100 g | 1000 mg GAE/100 g |
| digestate | material (ie 10,000 mg | material (ie 10,000 mg |
| | GAE/Litre) | GAE/Litre) |
| Polyphenol level in washed | 5 mg GAE/100 g material | 10 mg GAE/100 g material |
| starting sugar | | |
| Polyphenols content target | 48 mg GAE/100 g material | 48 mg GAE/100 g material |
| Polyphenols needed to | 43 mg GAE/100 g material | 43 mg GAE/100 g material |
| reach target | | |
| mL of digestate required to | 4.34 g of digestate per 100 | 2.17 g of digestate per 100 |
| prepare 100 g of a | g starting sugar | g starting sugar |
| composition containing | | |
| digestate and washed sugar | | |
| wherein the polyphenol | | |
| concentration is about 48 | | |
| mg GAE/100 g of material | | |

The skilled person will be able to determine the appropriate quantity based on the quantity of polyphenols in the digestate (or dunder) and the quantity (if any) in the starting sugar. Further, examples are set out in Table 7 below.

TABLE 7
Grams of polyphenol composition to add to base sugar in various
scenarios

| | | | Polyphenol | Grams of |
|---|---|---|---|---|
| | Dried Powder | | Top Up | polyphenol |
| | Polyphenol | Base Sugar | Required | composition |
| | Composition | mg GAE/ | mg GAE/ | required/100 g |
| | mg GAE/100 g | 100 g | 100 g | Grams |
| Scenario 1 | 7900 | 20 | 10 | 0.0013 |
| Scenario 2 | 7900 | 10 | 20 | 0.0025 |
| Scenario 3 | 7900 | 0 | 30 | 0.0038 |
| Scenario 4 | 7900 | 20 | 40 | 0.0051 |

### Example 10— Industrial Application of Polyphenol Composition to a Sugar

Two different base sugars (partially refined sugars traditionally sent to a refinery for further refining to white sugar) were used as the base for addition of various quantities of various dilutions of various polyphenol compositions. To determine the effect of the additive on the final sugar. The polyphenol compositions were mixed with sugar (alternatively the polyphenol composition can be added into the affination syrup before or after centrifuging) to evenly distribute the polyphenol composition throughout the sugar. The polarity (Pol), reducing sugar content (RS), moisture content, ash content, colour and polyphenol content (GAE) were determined by NIR and for some samples the polyphenol content confirmed by the laboratory method. The characteristics of the base and prepared sugars are in Table 8 and the polyphenol composition, dilution and volume used to prepare each sugar shown in Table 9 below.

TABLE 8
Characteristics of the base sugar and prepared sugars S1-S24

| | | | | | | | Lab GAE |
|---|---|---|---|---|---|---|---|
| | | | | | NIR | | mg/ |
| | NIR Pol | RS | Moisture | NIR Ash | Colour | NIR GAE | 100 g |
| Base sugar 1 | 99.52 | 0.13 | 0.11 | 0.10 | 673 | 20 | 21 |
| S1 | 99.33 | 0.14 | 0.11 | 0.13 | 976 | 23 | 24 |
| S2 | 99.26 | 0.15 | 0.13 | 0.13 | 1159 | 23 | 24 |
| S3 | 99.05 | 0.23 | 0.14 | 0.17 | 1197 | 32 | 26 |
| S4 | 99.14 | 0.22 | 0.14 | 0.17 | 1218 | 29 | 27 |
| S5 | 99.18 | 0.24 | 0.13 | 0.2 | 1358 | 35 | |
| S6 | 99.2 | 0.21 | 0.13 | 0.21 | 1589 | 33 | |
| S7 | 98.69 | 0.28 | 0.15 | 0.25 | 2510 | 47 | |
| S8 | 98.97 | 0.33 | 0.12 | 0.23 | 2672 | 38 | |
| S9 | 99.3 | 0.28 | 0.14 | 0.24 | 1929 | 36 | |
| S10 | 99.33 | 0.25 | 0.11 | 0.22 | 1797 | 32 | 30 |
| S11 | 99.16 | 0.34 | 0.12 | 0.2 | 2180 | 37 | 35 |
| S12 | 99.07 | 0.34 | 0.04 | 0.15 | 3128 | 37 | 54 |
| Base sugar 2 | 99.35 | 0.17 | 0.11 | 0.11 | 864 | 22 | 23 |
| S17 | 99.34 | 0.18 | 0.09 | 0.21 | 1436 | 24 | 26 |
| S18 | 99.38 | 0.22 | 0.13 | 0.24 | 1982 | 30 | 31 |
| S19 | 99.18 | 0.26 | 0.1 | 0.2 | 2672 | 31 | 39 |
| S20 | 98.92 | 0.27 | 0.11 | 0.18 | 3263 | 37 | 46 |
| S21 | 98.88 | 0.32 | 0.11 | 0.16 | 3684 | 40 | 56 |
| S22 | 98.73 | 0.33 | 0.31 | 0.19 | 4402 | 47 | |
| S22 | 99.03 | 0.28 | 0.1 | 0.13 | 3937 | 38 | 61 |
| S23 | 98.81 | 0.29 | 0.07 | 0.16 | 3602 | 41 | 56 |
| S24 | 98.65 | 0.36 | 0.23 | 0.31 | 4176 | 45 | |
| S24 | 99 | 0.32 | 0.06 | 0.19 | 3978 | | 86 |

TABLE 9
Polyphenol composition, dilution and volume added to the base
sugar to prepare sugars S1-S24

| | | | | ml dilution | |
|---|---|---|---|---|---|
| | | | | added to | Increase |
| | Polyphenol | PC GAE | Dilution of | 100 g base | in GAE |
| | Composition | mg/100 g | PC g/ml | sugar | mg/100 g |
| Base | | | | | |
| sugar 1 | | | | | |
| S1 | D1 | 6818 | 0.2/100 | 5 | 4 |
| S2 | D1 | 6818 | 0.2/100 | 10 | 4 |
| S3 | D1 | 6818 | 0.4/100 | 5 | 5 |
| S4 | D1 | 6818 | 0.4/100 | 10 | 6 |
| S5 | D1 | 6818 | 1/100 | 5 | 15 |
| S6 | D1 | 6818 | 1/100 | 10 | 13 |
| S7 | D1 | 6818 | 7/60 | 5 | 27 |
| S8 | D2 | 10789 | 7/60 | 2 | 18 |
| S9 | D2 | 10789 | 7/60 | 1 | 16 |
| S10 | D2 | 10789 | 7/60 | 0.5 | 10 |
| S11 | D2 | 10789 | 7/60 | 1.5 | 15 |
| S12 | D2 | 10789 | 7/60 | 2.5 | 33 |
| Base | | | | | |
| sugar 2 | | | | | |
| S17 | D2 | 10789 | 10/100 | 0.5 | 3 |
| S18 | D2 | 10789 | 10/100 | 1 | 8 |
| S19 | D2 | 10789 | 10/100 | 2 | 16 |
| S20 | D2 | 10789 | 10/100 | 3 | 23 |
| S21 | D2 | 10789 | 10/100 | 4 | 33 |
| S22 | D2 | 10789 | 10/100 | 5 | |
| S22 | D2 | 10789 | 10/100 | 5 | 38 |
| S23 | D2 | 10789 | 20/100 | 2.5 | 33 |
| S24 | D2 | 10789 | 20/100 | 5 | |
| S24 | D2 | 10789 | 20/100 | 5 | 63 |

### Example 11— Liquid Digestate Testing of Pesticide, Herbicide, Fungicide and Other Levels

Samples of liquid sugar cane juice vinasse digestate were commercially sourced and provided to the National Measurement Institute in Australia for analysis. The results provided are in Table 10 below.

TABLE 10
Impurity levels in vinasse
Organochlorine (OC) Pesticides

| | | |
|---|---|---|
| Aldrin | mg/kg | <0.02 |
| BHC-alpha | mg/kg | <0.02 |
| BHC-beta | mg/kg | <0.02 |
| BHC-delta | mg/kg | <0.02 |
| BHC-Total | mg/kg | <0.02 |
| Chlordane | mg/kg | <0.02 |
| DDD-o.p. | mg/kg | <0.02 |
| DDE-o.p. | mg/kg | <0.02 |
| DDT-o.p. | mg/kg | <0.02 |
| DDD-p.p. | mg/kg | <0.02 |
| DDE-p.p. | mg/kg | <0.02 |
| DDT-p.p. | mg/kg | <0.02 |
| DDT-total | mg/kg | <0.02 |
| Dicofol | mg/kg | <0.02 |
| Dieldrin | mg/kg | <0.02 |
| Endosulfan-a. | mg/kg | <0.02 |
| Endosulfan-b. | mg/kg | <0.02 |
| Endosulfan- | mg/kg | <0.02 |
| Sulphate | | |
| Endosulfan- | mg/kg | <0.02 |
| Total | | |
| Endrin | mg/kg | <0.05 |
| HCB | mg/kg | <0.01 |
| Heptachlor | mg/kg | <0.01 |
| Heptachlor- | mg/kg | <0.01 |
| Epoxide | | |
| Lindane | mg/kg | <0.02 |
| Methoxychlor | mg/kg | <0.05 |
| Nonachlor | mg/kg | <0.05 |
| Trichlorfon | mg/kg | <0.02 |

Organophosphate (OP) Pesticides

| | | |
|---|---|---|
| Acephate | mg/kg | <0.01 |
| Azinphos ethyl | mg/kg | <0.02 |
| Temephos | mg/kg | <0.05 |
| Azinphos methyl | mg/kg | <0.02 |
| Bromophos ethyl | mg/kg | <0.05 |
| Carbophenothion | mg/kg | <0.05 |
| Chlorfenvinphos | mg/kg | <0.05 |
| Chlorpyrifos | mg/kg | <0.01 |
| Chlorpyrifos | mg/kg | <0.02 |
| Chlorthal dimethyl | mg/kg | <0.02 |
| Coumaphos | mg/kg | <0.01 |
| Demeton-S-Methyl | mg/kg | <0.01 |
| Diazinon | mg/kg | <0.02 |
| Dioxathion | mg/kg | <0.05 |
| Dichlorvos | mg/kg | <0.02 |
| Dimethoate | mg/kg | <0.02 |
| Ethion | mg/kg | <0.05 |
| Fenamiphos | mg/kg | <0.01 |
| Fenchlorphos | mg/kg | <0.05 |
| Fenitrothion | mg/kg | <0.02 |
| Fenthion | mg/kg | <0.01 |
| Formothion | mg/kg | <0.05 |
| Malathion | mg/kg | <0.02 |
| Methacrifos | mg/kg | <0.05 |
| Methamidophos | mg/kg | <0.01 |
| Methidathion | mg/kg | <0.01 |
| Mevinphos | mg/kg | <0.02 |
| Monocrotophos | mg/kg | <0.01 |
| Omethoate | mg/kg | <0.02 |
| Parathion ethyl | mg/kg | <0.02 |
| Parathion methyl | mg/kg | <0.02 |
| Phorate | mg/kg | <0.02 |
| Phosalone | mg/kg | <0.05 |
| Phosmet | mg/kg | <0.02 |
| Phosphamidon | mg/kg | <0.05 |
| Pirimiphos methyl | mg/kg | <0.02 |
| Profenofos | mg/kg | <0.05 |
| Prothiofos | mg/kg | <0.01 |
| Terbufos | mg/kg | <0.05 |
| Triazophos | mg/kg | <0.05 |

Fungicides

| | | |
|---|---|---|
| Benalaxyl | mg/kg | <0.01 |
| Bistertanol | mg/kg | <0.05 |
| Boscalid | mg/kg | <0.01 |
| Captan | mg/kg | <0.05 |
| Chlorothalonil | mg/kg | <0.01 |
| Cyproconazole | mg/kg | <0.01 |
| Cyprodinil | mg/kg | <0.01 |
| Diclofluanid | mg/kg | <0.02 |
| Dicloran | mg/kg | <0.02 |
| Difenoconazole | mg/kg | <0.01 |
| Dimethomorph | mg/kg | <0.01 |
| Diphenylamine | mg/kg | <0.02 |
| Epoxiconazole | mg/kg | <0.01 |
| Fenarimol | mg/kg | <0.05 |
| Fludioxonil | mg/kg | <0.02 |
| Fenpyrazamine | mg/kg | <0.01 |
| Flusilazole | mg/kg | <0.01 |
| Hexaconazole | mg/kg | <0.05 |
| Imazalil | mg/kg | <0.05 |
| Iprodione | mg/kg | <0.02 |
| Kresoxim methyl | mg/kg | <0.02 |
| Mandipropamid | mg/kg | <0.01 |
| Metalaxyl | mg/kg | <0.01 |
| Metrafenone | mg/kg | <0.01 |
| Myclobutanil | mg/kg | <0.02 |
| Oxadixy 1 | mg/kg | <0.05 |
| Oxycarboxin | mg/kg | <0.05 |
| Pacloburtrazol | mg/kg | <0.01 |
| Penconazole | mg/kg | <0.02 |
| Piperonyl butoxide | mg/kg | <0.01 |
| Prochloraz | mg/kg | <0.05 |
| Procymidone | mg/kg | <0.02 |
| Propamocarb | mg/kg | <0.02 |
| Propiconazole | mg/kg | <0.01 |
| Pyraclostrobin | mg/kg | <0.01 |
| Pyrimethanil | mg/kg | <0.01 |
| Quintozene | mg/kg | <0.01 |
| Tebuconazole | mg/kg | <0.01 |
| Tolclophos methyl | mg/kg | <0.01 |
| Tolylfluanid | mg/kg | <0.05 |
| Triadimefon | mg/kg | <0.05 |
| Triaimenol | mg/kg | <0.01 |
| Vinclozolin | mg/kg | <0.02 |

Herbicides

| | | |
|---|---|---|
| Atrazine | mg/kg | <0.01 |
| Bromacil | mg/kg | <0.01 |
| Carfentrazone Ethyl | mg/kg | <0.02 |
| Ethofumesate | mg/kg | <0.01 |
| Isoxaben | mg/kg | <0.01 |
| Linuron | mg/kg | <0.01 |
| Methabenzthiazuron | mg/kg | <0.01 |
| Metolachlor | mg/kg | <0.01 |
| Metribuzin | mg/kg | <0.01 |
| Molinate | mg/kg | <0.05 |
| Oxyfluorfen | mg/kg | <0.01 |
| Napropamide | mg/kg | <0.01 |
| Norflurazon | mg/kg | <0.01 |
| Pendimethalin | mg/kg | <0.01 |
| Propachlor | mg/kg | <0.02 |
| Trifluralin | mg/kg | <0.01 |

Carbamates

| | | |
|---|---|---|
| Methiocarb | mg/kg | <0.05 |

Acaricides

| | | |
|---|---|---|
| Buprofezin | mg/kg | <0.01 |
| Propyzamide | mg/kg | <0.01 |
| Simazine | mg/kg | <0.01 |
| Clofentezine | mg/kg | <0.01 |
| Disulphoton | mg/kg | <0.01 |
| Etoxazole | mg/kg | <0.01 |
| Hexythiazox | mg/kg | <0.01 |
| Propargite | mg/kg | <0.01 |
| Tebufenpyrad | mg/kg | <0.02 |
| Tetradifon | mg/kg | <0.02 |

Others

| | | |
|---|---|---|
| Chlorfenapyr | mg/kg | <0.02 |

Phenols

| | | |
|---|---|---|
| O-Phenyphenol | mg/kg | <0.02 |

Carbamates

| | | |
|---|---|---|
| Aldicarb (incl sulfoxide | mg/kg | <0.01 |
| & sulfonem) | | |
| Carbaryl | mg/kg | <0.01 |
| Pirimicarb | mg/kg | <0.02 |

Synthetic Pyrethroids

| | | |
|---|---|---|
| Bifenthrin | mg/kg | <0.01 |
| Bioresmethrin | mg/kg | <0.02 |
| Cyfluthrin-b. | mg/kg | <0.01 |
| Cyfluthrin | mg/kg | <0.01 |
| Cyhalothrin-1. | mg/kg | <0.01 |
| Cyhalothrin | mg/kg | <0.01 |
| Cypermethrin | mg/kg | <0.01 |
| Deltamethrin | mg/kg | <0.02 |
| Esfenvalerate | mg/kg | <0.01 |
| Fenvalerate | mg/kg | <0.01 |
| Fluvalinate | mg/kg | <0.01 |
| tau-Fluvalinate | mg/kg | <0.02 |
| Permethrin | mg/kg | <0.02 |
| Phenothrin | mg/kg | <0.02 |
| Pyrethrins | mg/kg | <0.02 |

Insecticide

| | | |
|---|---|---|
| Acetamiprid | mg/kg | <0.01 |
| Fipronil | mg/kg | <0.01 |
| Chlorantaniliprole | mg/kg | <0.01 |
| Clothianidin | mg/kg | <0.01 |
| Emamectin | mg/kg | <0.01 |
| Fenoxycarb | mg/kg | <0.02 |
| Flubendiamide | mg/kg | <0.02 |
| Indoxacarb | mg/kg | <0.01 |
| Methoxyfenozide | mg/kg | <0.02 |
| Novaluron | mg/kg | <0.05 |
| Py ri proxyfen | mg/kg | <0.01 |
| Spinetoram | mg/kg | <0.01 |
| Spirotetramat | mg/kg | <0.01 |
| Thiamethoxam | mg/kg | <0.01 |

C5 Residues

| | | |
|---|---|---|
| Azoxystrobin | mg/kg | <0.01 |
| Vamidothion | mg/kg | <0.05 |
| Benomyl | mg/kg | <0.05 |
| Benzyladenine | mg/kg | <0.0005 |
| Carbendazim | mg/kg | <0.01 |
| Diuron mg/kg | mg/kg | <0.05 |
| Fenhexamid | mg/kg | <0.02 |
| Fenpyroximate | mg/kg | <0.05 |
| Imidacloprid | mg/kg | <0.01 |
| Methomyl | mg/kg | <0.02 |
| Pymetrozine | mg/kg | <0.01 |
| Soinosad | mg/kg | <0.01 |
| Tebufenozide | mg/kg | <0.02 |
| Thiabendazole | mg/kg | <0.01 |
| Thiacloprid | mg/kg | <0.02 |
| Trifloxystrobin | mg/kg | <0.01 |

Trace Elements

| | | |
|---|---|---|
| Antimony | mg/kg | 0.021 |
| Arsenic | mg/kg | 0.18 |
| Cadmium | mg/kg | <0.01 |
| Copper | mg/kg | 0.39 |
| Lead | mg/kg | 0.055 |
| Mercury | mg/kg | <0.01 |
| Selenium | mg/kg | 0.099 |
| Tin | mg/kg | 0.011 |
| Zinc | mg/kg | 2.1 |

1-119. (canceled)

120. A food grade polyphenol composition comprising liquid or powdered sugar cane vinasse and/or sugar cane digestate, wherein the vinasse or digestate has 500 to 15,000 mg GAE/100 g polyphenols.

121. The polyphenol composition of claim 120, wherein the sugar cane vinasse and/or sugar cane digestate is a sugar juice vinasse/digestate or a molasses vinasse/digestate or a combination thereof.

122. The polyphenol composition of claim 120, wherein the sugar cane vinasse and/or sugar cane digestate is a sugar cane digestate.

123. The polyphenol composition of claim 122, wherein the sugar cane digestate is a sugar cane vinasse digestate.

124. The polyphenol composition of claim 120, wherein the vinasse or digestate has:
(i) no odour; or
(ii) no odour when combined with white refined sucrose to produce a 100 mg GAE polyphenol/100 g carbohydrate sugar; or
(iii) no odour or reduced odour because:
(a) the odour is less that the odour of the sugar cane vinasse and/or sugar cane digestate used to prepare the polyphenol composition;
(b) the odour is less than the usual odour of sugar cane vinasse and/or sugar cane digestate;
(c) the polyphenol composition has an odour intensity of 0-3 according to the VDI 3882-1 olfactometry standard;
(d) the polyphenol composition has no odour when combined with white refined sucrose or raw mill sugar to produce a 10 mg GAE polyphenol/100 g carbohydrate sugar;
(e) the volatile organic content of the sugar cane vinasse and/or sugar cane digestate is reduced; or
(f) combinations of (a) to (e).

125. The polyphenol composition of claim 120, wherein the composition comprises sugar cane vinasse and/or sugar cane digestate formed during preparation of bioethanol, rum, amino/organic acid, yeast propagation or a combination thereof.

126. The polyphenol composition of claim 125, wherein the vinasse and/or digestate have a Chemical Oxygen Demand (COD) of 30-150 g O₂/L and/or a biochemical oxygen demand (BOD) of about 30-80% of the COD.

127. The polyphenol composition of claim 122, wherein the digestate is anaerobic digestate.

128. The polyphenol composition of claim 120, wherein (i) the vinasse is sugarcane juice vinasse, massecuite vinasse and combinations thereof; and (ii) the digestate is sugar cane vinasse digestate.

129. The polyphenol composition of claim 120, wherein digestate also had less than 1 mg/kg arsenic, less than 0.30 mg/kg antimony; less than 0.03 mg/kg cadmium, 1.9 mg/kg selenium; less than 0.004 mg/kg mercury; and 0.12 mg/kg lead.

130. The polyphenol composition of claim 120, wherein the digestate and/or vinasse is soluble.

131. The polyphenol composition of claim 120, wherein (i) the digestate is powdered and is <40% w/v plant fibre, <35% w/v ash and/or >7% w/v polyphenols; or (ii) the digestate is concentrated or diluted to 40% solids in liquid.

132. The polyphenol composition of claim 131, wherein the digestate includes one or more of (i) more than 7000 mg GAE/100 g polyphenols; the powdered digestate is less than 5% moisture by weight; and the powdered digestate has a pH 9.0 to 9.6 when 1 g of powder is dissolved in 10 ml water.

133. The polyphenol composition of claim 120, wherein the polyphenol composition is 5,000 to 15,000 mg GAE/100 g polyphenols.

134. The polyphenol composition of claim 120, wherein the polyphenol composition is <5 Pol % w/w.

135. The polyphenol composition of claim 120, wherein the polyphenol composition is not an extract.

136. The polyphenol composition of claim 120, wherein the polyphenol composition is an affinity filtration filtrate and/or an ion-exchange resin filtrate.

137. A method of preparing a powdered polyphenol composition of claim 1 comprising spray drying liquid sugar cane digestate and/or sugar cane vinasse.

138. The method of claim 137, wherein prior to spray drying the high boiling point fraction of the digestate/vinasse is removed under reduced pressure.

139. A method of preparing a liquid polyphenol composition comprising:
(a) preparing a powdered polyphenol composition in accordance with claim 137; and
(b) reconstituting the powder of (a) as a liquid by combining the powder with water, affination syrup, molasses or combinations thereof.
